(19) United States
(12) Patent Application Publication
(10) Pub. No.: US 2025/0349165 A1
(43) Pub. Date: Nov. 13, 2025

(54) HIGH INTEGRITY LOCATION MONITORING

(71) Applicant: Apple Inc., Cupertino, CA (US)

(72) Inventors: Ernst T. Erdmann, San Francisco, CA (US); Michael P. Dal Santo, San Francisco, CA (US); Santhoshkumar Mani, Dublin, CA (US); Robert W. Brumley, San Jose, CA (US); Kevin W. Watts, Mountain View, CA (US); Richard B. Warren, Redwood City, CA (US)

(73) Assignee: Apple Inc., Cupertino, CA (US)

(21) Appl. No.: 19/083,088

(22) Filed: Mar. 18, 2025

Related U.S. Application Data
(60) Provisional application No. 63/646,416, filed on May 13, 2024.

(51) Int. Cl. G07C 9/00; G01S 3/14; G01S 13/02; H04B 17/318; H04W 4/021

(52) U.S. Cl. CPC G07C 9/00182; G01S 3/14; G01S 13/0209; H04B 17/318; H04W 4/021; G07C 2009/0019

(57) ABSTRACT

Embodiments of the disclosed technology relate to improvements in location estimation and prediction for mobile devices while preserving energy. The use of classifiers is provided which preserves energy usage of the mobile device while providing contextually aware information for various stages. The use of a motion classifier and ranging in the context of access devices, the use of directional motion classifiers to reduce the latency in detection that a mobile device has entered a geofence area, and methods of improving location estimates and increasing geofence boundaries to prevent false exits from a geofenced area are disclosed.

### CROSS-REFERENCES TO OTHER APPLICATIONS

This application claims priority to U.S. Provisional Application No. 63/646,416, for “HIGH INTEGRITY LOCATION MONITORING” filed on May 13, 2024, which is herein incorporated by reference in its entirety for all purposes.

### BACKGROUND

Smart devices or smart systems, such as home automation systems or access devices (e.g., a smart lock), rely on a device's location, or related information, to provide functionality based on the provided location. However, existing location services for devices suffer from various limitations, including a lack of high accuracy, high latency, or false positive classifications of a mobile device entering or leaving an area. These and other limitations impede the utility of these smart devices or systems. Thus, there is a need to improve location-based services that may improve the functionality provided by such smart systems.

### BRIEF SUMMARY

Aspects of the disclosed technology include a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One aspect of the disclosed technology includes a method performed by a mobile device for providing access control. The method also includes determining the mobile device crossed a geofence toward a predefined location. The method also includes responsive to crossing the geofence, communicating with a lock mechanism providing access to the predefined location via a wireless protocol. The method also includes classifying the mobile device as moving toward the predefined location based on wireless signals of the wireless protocol received from the lock mechanism. The method also includes dynamically adjusting a ranging rate with the lock mechanism based on the wireless signals. The method also includes providing an unlock message to the lock mechanism, the message indicating a range between the lock mechanism and the mobile device is less than a threshold. Other embodiments of the disclosed technology include corresponding computer systems, apparatus, and computer programs recorded on one or more computer storage devices, each configured to perform the actions of the methods.

Implementations may include one or more of the following features. The method where classifying the mobile device is based on sensor data of the mobile device. The sensors include an accelerator and gyroscope. The method may include, suspending communication between the mobile device and the lock mechanism. The method may include, classifying the mobile device as being in a stationary state. The method may include, classifying the mobile device as being in a non-stationary state and resuming communication between the mobile device and the lock mechanism. The method may include, suspending communication between the mobile device and the lock mechanism after the mobile device has not met the threshold range within a predefined period of time after crossing the geofence. The method may include, classifying the mobile device as being in a stationary state. The method may include utilizing an always on processor of the computing device to determine the user's proximity to a predetermined location. A non-transitory computer readable medium containing instructions that, when executed by one or more processors, may cause the one or more processors to perform any of the methods herein. A system may include one or more processors and non-transitory computer readable medium containing instructions that, when executed by one or more processors, cause the system to perform any of the methods of any. Implementations of the described techniques may include hardware, a method or process, or computer software on a computer-accessible medium.

One aspect of the disclosed technology includes a method performed by a mobile device for tracking locations of the mobile device. The method also includes receiving location data measured over time using at least one of wireless network circuitry and global navigation satellite system (gnss) circuitry. The method also includes monitoring, based on the location data, a proximity state of the mobile device relative to a predefined location. The method also includes determining, using the location data, that the proximity state of the mobile device has transitioned from a far state to a near state relative to the predefined location. The method also includes determining, by a directional motion classifier using the location data, that the mobile device is approaching the predefined location. The method also includes progressively increasing the update frequency for measuring the location data as the mobile device approaches the predefined location, thereby obtaining updated location data. The method also includes determining the mobile device has entered the predefined location based on the updated location data. Other embodiments of the disclosed technology include corresponding computer systems, apparatus, and computer programs recorded on one or more computer storage devices, each configured to perform the actions of the methods.

Aspects of the disclosed technology may include one or more of the following features. The method may include determining, using motion data from motion sensors of the mobile device, that the mobile device is approaching the predefined location. Determining that the proximity state of mobile device has transitioned from a far state to a near state relative to the predefined location further may include, establishing a first geofence relative to the predefined location and determining whether the mobile device has crossed the first geofence. Determining the mobile device has entered the predefined location may include determining that the mobile device has crossed a boundary of a second geofence, the second geofence contained within the first geofence. The method may include increasing the update frequency for measuring the location data in response to the transition to the near state. The directional motion classifier is activated based on an estimated time of arrival to the predefined location. The directional motion classifier includes a displacement model that estimates a future direction or location of the mobile device. The frequency for measuring location is based on the estimated future direction or future location of the mobile device. The directional motion classifier is activated based on the transition of the proximity state of the mobile device from a far state to a near state relative to the predefined location. Implementations of the described techniques may include hardware, a method or process, or computer software on a computer-accessible medium.

One aspect of the disclosed technology includes a method performed by a mobile device for tracking locations of the mobile device. The method also includes determining the mobile device is at a predefined location having a geofence defined for the mobile device. The method also includes receiving first location data measured using global navigation satellite system (gnss) circuitry and second location measured using at least one of wireless network circuitry and motions sensors. The method also includes determining the first location data indicates the mobile device has crossed a first boundary setting of the geofence. The method also includes comparing the first location data to the second location data. The method also includes determining the first location data indicating the mobile device has crossed the first boundary setting of the geofence is not may include with the second location data. The method also includes determining an uncertainty of a current location of the mobile device using the first location data and the second location data. The method also includes changing the geofence to have a second boundary setting that is larger than the first boundary setting based on the uncertainty, thereby causing the current location to remain at the predefined location. Other embodiments of the disclosed technology include corresponding computer systems, apparatus, and computer programs recorded on one or more computer storage devices, each configured to perform the actions of the methods.

Aspects of the disclosed technology may include one or more of the following features. The method where determining the uncertainty of a current location may include calculating an absolute value of a difference between the first location data and the second location data. Determining the uncertainty of a current location may include is based on a weighted average of the uncertainty in measuring the first location data and the uncertainty in measuring the second location data. The weights of the weighted average may be based on historical accuracy information related to the first location data and the second location data. The method may include comparing the first location data to previous location data and determining the uncertainty based on the comparison. The method may include comparing the first location data to previous location data and determining the uncertainty based on the comparison. The method may include determining the mobile device has crossed the second boundary setting, thereby determining the mobile device has left the predefined location. The first location data may not be consistent with the second location data when the first location data is outside the first boundary setting while the second location data is inside the first boundary setting. The first location data not being consistent with the second location data may include a difference in location which exceeds a threshold based on historical differences between the first location data and the second location data. The method may include reducing a boundary setting of the geofence in response to determining that updated first location data and updated second location are consistent with one another. The updated first location data and the updated second location data may be consistent when the updated first location data and the updated second location data are within the same geofence or less than a threshold distance from one another. The method may include delaying an update to the current location until the first location data indicates that it has crossed the second boundary setting. The geofence may have an upper limit to the second boundary setting based on an upper limit metric. Other embodiments of the disclosed technology include corresponding computer systems, apparatus, and computer programs recorded on one or more computer storage devices, each configured to perform the actions of the methods.

One aspect of the disclosed technology includes a computer readable medium storing instructions of an application for controlling an electronic device to perform a method. The computer readable medium storing instructions also includes obtaining first information. The instructions also include providing the first information to an operating system, where the first information is information for performing any of the above methods.

One aspect of the disclosed technology includes a computer readable medium storing instructions of an application for controlling an electronic device to perform a method. The computer readable medium storing instructions also includes obtaining first information. The instructions also include performing a first operation with the first information, where the first information is based on any of the above methods.

Aspects of the disclosed technology may include one or more of the following features. The method where the determination of the mobile device as placed on the first side or the second side of the lock mechanism is based on a differential signal strength. The second wireless protocol is an ultra-wide band protocol. The differential signal strength may be based on a distance between one or more antennas within the lock mechanism. Providing an unlock message to the lock mechanism may occur after determining that the mobile device is approaching from the first side of the lock mechanism. Other embodiments of the disclosed technology include corresponding computer systems, apparatus, and computer programs recorded on one or more computer storage devices, each configured to perform the actions of the methods.

### BRIEF DESCRIPTION OF THE DRAWINGS

FIG. 1 shows a sequence diagram for performing a ranging measurement between an access device and a mobile device according to embodiments of the present disclosure.

FIG. 2 illustrates a sequence diagram involving an access device and a mobile device with a multiple-antenna array.

FIG. 3 illustrates a block diagram of an example access device and mobile device, according to at least one embodiment.

FIG. 4 illustrates a two-dimensional representation of an approach between a mobile device and an access device, according to at least one embodiment.

FIG. 5 illustrates a diagram of an example method for unlocking of a lock mechanism, according to at least one embodiment.

FIG. 6 illustrates a two-dimensional representation of an approach between a mobile device and a geofence, according to at least one embodiment.

FIG. 7 illustrates a diagram of an example method for reducing latency for detecting that a mobile device has entered a geofenced area, according to at least one embodiment.

FIG. 8 illustrates a two-dimensional representation of expanding geofenced areas based on uncertainty measurements.

FIG. 9 illustrates a diagram of an example method for reducing false exits of a mobile device from a geofenced area, according to at least one embodiment.

FIG. 10 illustrates a block diagram of an always on processor (AOP), according to at least one embodiment.

FIG. 11 illustrates a block diagram of an example electronic device, according to at least one embodiment.

FIGS. 12A-12F show example embodiments implemented using application program interfaces (APIs).

### DETAILED DESCRIPTION

Generally, location services provided by a mobile device (e.g., a cellular phone or mobile device), are limited in at least several respects. Location services may include determining the location of the mobile device or actions taken by or caused to be taken in response to the location of the mobile device (e.g., smart home systems, home automation, door lock or door unlock).

For instance, achieving high accuracy on a mobile device may require substantial power consumption through “brute force” location tracking, such as when location services for the device are always turned on. This may lead to substantial power drain and be impractical in devices with limited energy capabilities. Other limitations may arise from a lack of the precision required and contextual awareness with respect to an entry point (e.g., a front door or a lock). The lack of high precision and relative position of the device to the entry point limits the usefulness of any devices that may operate relative to the entry point.

Further, there is often high latency or a delay in recognizing when a user enters a geo-fenced area. This leads to a degraded user experience as location-based automation services “lag” and cannot perform until after the user is already in the geo-fenced area due to the latency or delay. Additionally, a mobile device may report that the device has left a geo-fenced area due to a lack of high fidelity in monitoring its true location. This lack of high fidelity in a location determined by the mobile device may impact location-based actions. For instance, actions taken responsive to whether a mobile device is inside or outside a geofence may be impacted due to the mobile device falsely reporting it has left the geofence.

As further discussed below, embodiments of the disclosed technology may address these limitations through dynamic algorithms, adjusting ranging and sensor rates, and motion classifiers to overcome these and other limitations.

In various embodiments, the rate (e.g., a ranging rate) at which a mobile device and an access device communicate with one another can be increased based on a distance between the mobile device and the access device or a signal strength of a signal between the mobile device and the access device. Additional signals may be used once a threshold distance or signal strength is reached, ensuring that the access device provides as the mobile device approaches the access device.

In various embodiments, a proximity classifier can classify a mobile device as near or far from a geofenced area. Upon transitioning from a far classification to a near classification, a directional motion classifier may be used to adjust the rate of requesting a location (e.g., through GPS) by the mobile device. The adjustment may be based on the direction, speed of travel, and/or predicted future location. The increased rate may decreased latency in identifying or verifying that the mobile device has entered into the geofenced area.

In various embodiments, upon a first location data (e.g., GPS) indicating that a mobile device has left a first geofence, the first geofence may be expanded to produce a second geofence. A mismatch between a first location data and a second location data (e.g., Wi-Fi or sensor based location data) may cause a geofence to be expanded based on the uncertainty or other metric (e.g., an effective distance metric) between the first location data and the second location data. The second geofence may be used to determine if the first location data still indicates an exit from the second geofence, or if the device has returned to the non-expanded first geofence.

Prior to a discussion of specific techniques, a discussion of “ranging” is provided below. Various embodiments of the disclosed technology may use methods related to ranging in order to determine information about the relative distance between two devices. This distance, whether spatial or in time, may be used to trigger proximity-based actions in various devices.

### I. Ranging

In some embodiments discussed below, “ranging” can be used to determine a distance or time between two devices, such as a mobile device and an access device. As further explained herein, the mobile device and the access device may be the devices discussed below with respect to improvements to door unlock or access technology. The ranging can be performed at a specified rate, which may be fixed or dynamic (e.g., adjustable).

A mobile device or an access device can include circuitry for performing ranging measurements. Such circuitry can include one or more dedicated antennas (e.g., 3) and circuitry for processing measured messages (e.g., signals). The ranging measurements can be performed using the time-of-flight of pulses between the two mobile devices. In some implementations, a round-trip time (RTT) is used to determine distance information, e.g., for each of the antennas. In other implementations, a single-trip time in one direction can be used. The pulses may be formed using ultra-wideband (UWB) radio technology.

### A. Sequence Diagram

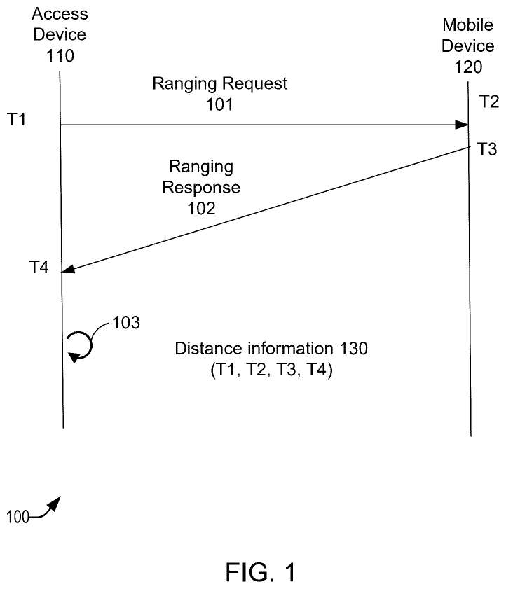

FIG. 1 shows a sequence diagram for performing a ranging measurement between an access device and a mobile device according to embodiments of the present disclosure. The access device can be a part of infrastructure for controlling access to a restricted area. The mobile device can be a smartphone, a smartwatch, a tablet computer, etc. Although FIG. 1 shows a single measurement, the process can be repeated to perform multiple measurements over a time interval as part of a ranging session, where such measurements can be averaged or otherwise analyzed to provide a single distance value, e.g., for each antenna. FIG. 1 illustrates a message sequence of a single-sided two-way ranging protocol. The techniques presented in this application are also applicable to other ranging protocols such as double-sided two way ranging.

Access device 110 can initiate a ranging measurement (operation) by transmitting a ranging request 101 to a mobile device 120 (e.g., a smartphone, a smartwatch). Ranging request 101 can include a first set of one or more pulses. The ranging measurement can be performed using a ranging wireless protocol (e.g., ultrawide band (UWB)). The ranging measurement may be triggered in various ways, e.g., based on user input and/or authentication using another wireless protocol, e.g., Bluetooth low energy (BLE). In one example, ranging can start upon receiving certain information in an advertisement signal from a beacon device.

At T₁, access device 110 transmits ranging request 101. At T₂, mobile device 120 receives ranging request 101. T₂ can be an average received time when multiple pulses are in the first set. Mobile device 120 can be expecting ranging request 101 within a time window based on previous communications, e.g., using another wireless protocol. The ranging wireless protocol and the another wireless protocol can be synchronized so that mobile device 120 can turn on the ranging antenna(s) and associated circuitry for a specified time window, as opposed to leaving them on for an entire ranging session.

In response to receiving the ranging request 101, mobile device 120 can transmit ranging response 102. As shown, ranging response 102 is transmitted at time T₃, e.g., a transmitted time of a pulse or an average transmission time for a set of pulses. T₂ and T₃ may also be a set of times for respective pulses. Ranging response 102 can include times T₂ and T₃ so that access device 110 can compute distance information. As an alternative, a delta between the two times (e.g., T₃-T₂) can be sent. The delta can be referred to as a reply time.

At T₄, access device 110 can receive ranging response 102. Like the other times, T₄ can be a single time value or a set of time values.

At 103, access device 110 computes distance information 130, which can have various units, such as distance units (e.g., meters) or as a time (e.g., milliseconds). Time can be equivalent to a distance with a proportionality factor corresponding to the speed of light. In some embodiments, a distance can be computed from a total round-trip time, which may equal T₂-T₁+T₄-T₃. More complex calculations can also be used, e.g., when the times correspond to sets of times for sets of pulses and when a frequency correction is implemented.

### B. Triangulation

In some embodiments, a mobile device can have multiple antennas, e.g., to perform triangulation. The separate measurements from different antennas can be used to determine a two-dimensional (2D) position, as opposed to a single distance value that could result from anywhere on a circle/sphere around the mobile device. The two-dimensional position can be specified in various coordinates, e.g., Cartesian or polar, where polar coordinates can comprise an angular value and a radial value.

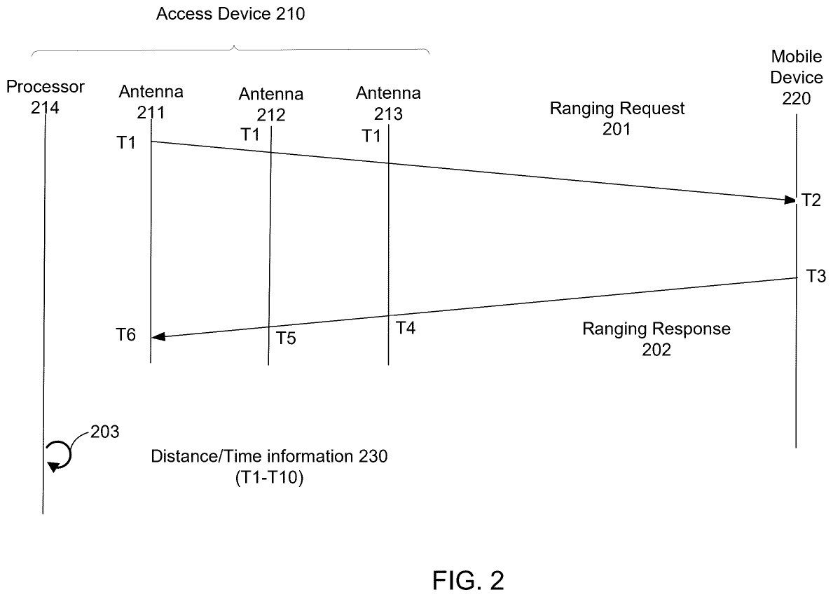

FIG. 2 shows a sequence diagram of a ranging operation involving an access device 210 having three antennas 211-213 according to embodiments of the present disclosure. Antennas 211-213 can be arranged to have different orientations, e.g., to define a field of view for performing ranging measurements. FIG. 2 illustrates a message sequence of a single sided two-way ranging protocol. The techniques presented in this application are also applicable to other ranging protocols such as double-side two way ranging.

In this example of FIG. 2, antenna 211 transmits a packet (including one or more pulses) that is received by mobile device 220. This packet can be part of ranging requests 201.

In some embodiments, access device 210 can have multiple antennas itself. In such an implementation, an antenna of access device 210 can send a packet to a particular antenna (as opposed to a broadcast) of mobile device 220, which can respond to that particular packet. Mobile device 220 can listen at a specified antenna so that both devices know which antennas are involved, or a packet can indicate which antenna a message is for. For example, a first antenna can respond to a received packet; and once the response is received, another packet can be sent to a different antenna. Such an alternative procedure may take more time and power.

The packet of ranging requests 201 are received at time T₂. In some instances, the antenna(s) (e.g., ultrawideband (UWB) antennas) of mobile device 220 can listen at substantially the same time and respond independently. Mobile device 220 provides ranging response 202, which is sent at time T₃. Access device 210 can receive the ranging response at one or more of antennas 211, 212, 213. Access device 210 receives the ranging responses at times T₄, T₅, and T₆, respectively.

At 203, processor 214 of access device 210 computes distance information 230, e.g., as described herein. Processor 214 can receive the times from the antennas, and more specifically from circuitry (e.g., UWB circuitry) that analyzes messages from antennas 211-213. As described later, processor 214 can be an always-on-processor that uses less power than an application processor that can perform more general functionality. Distance information 230 can be used to determine a 2D or 3D position of mobile device 220, where such position can be used to configure a display screen of mobile device 220. For instance, the position can be used to determine the location of mobile device 220 in a congested environment, e.g., the position relative to one or more access devices (e.g., access device 210), the position of a mobile device in a line, a position relative to an entryway, a position in a 2D grid, the position of mobile device 220 in 1D, 2D, or 3D distance/position ranges.

In some embodiments, to determine which ranging response is from which antenna, mobile device 220 can inform access device 210 of the order of response messages that are to be sent, e.g., during a ranging setup handshake, which may occur using another wireless protocol. In other embodiments, the ranging responses can include identifiers, which indicate which antenna sent the message. These identifiers can be negotiated in a ranging setup handshake.

Messages in ranging requests 201 and ranging responses 202 can include very little data in the payload, e.g., by including few pulses. Using few pulses can be advantageous. The environment of a mobile device (potentially in a pocket) can make measurements difficult. In some instances, larger payloads, such as a payload containing the response time of multiple access devices, are contemplated. As another example, an antenna of one device might face a different direction than the direction from which the other device is approaching. Thus, it is desirable to use high power for each pulse, but there are government restrictions (as well as battery concerns) on how much power can be used within a specified time window (e.g., averaged over 1 millisecond). The packet frames (e.g., ranging frames) containing these messages can be on the order of 130 to 310 microseconds long.

### C. Ultra-Wide Band (UWB)

The wireless protocol used for ranging can have a narrower pulse (e.g., a narrower full width at half maximum (FWHM)) than a first wireless protocol (e.g., Bluetooth) used for initial authentication or communication of ranging settings. In some implementations, the ranging wireless protocol (e.g., UWB) can provide distance accuracy of 5 cm or better. In various embodiments, the frequency range can be between 3.1 to 10.6 Gigahertz (GHz). Multiple channels can be used, e.g., one channel at 6.5 GHz another channel at 8 GHz. Thus, in some instances, the ranging wireless protocol does not overlap with the frequency range of the first wireless protocol (e.g., 2.4 to 2.485 GHz).

The ranging wireless protocol can be specified by IEEE 802.15.4, which is a type of UWB. Each pulse in a pulse-based UWB system can occupy the entire UWB bandwidth (e.g., 500 megahertz (MHz)), thereby allowing the pulse to be localized in time (i.e., narrow width in time, e.g., 0.5 ns to a few nanoseconds). In terms of distance, pulses can be less than 60 cm wide for a 500 MHz-wide pulse and less than 23 cm for a 1.3 GHz-bandwidth pulse. Because the bandwidth is so wide and width in real space is so narrow, very precise time-of-flight measurements can be obtained.

Each one of ranging messages (also referred to as frames or packets) can include a sequence of pulses, which can represent information that is modulated. Each data symbol in a frame can be a sequence. The packets can have a preamble that includes header information, e.g., of a physical layer and a MAC layer, and may include a destination address. In some implementations, a packet frame can include a synchronization part and a start frame delimiter, which can line up timing.

A packet can include how security is configured and include encrypted information, e.g., an identifier of which antenna sent the packet. The encrypted information can be used for further authentication. However, for a ranging operation, the content of the data may not need to be determined. In some embodiments, a timestamp for a pulse of a particular piece of data can be used to track a difference between transmission and reception. Content (e.g., decrypted content) can be used to match pulses so that the correct differences in times can be computed. In some implementations, the encrypted information can include an indicator that authenticates which stage the message corresponds, e.g., ranging requests 201 can correspond to stage 1 and ranging responses 202 can correspond to stage 2. Such use of an indicator may be helpful when more than two devices are performing ranging operations in near each other.

The narrow pulses (e.g., ˜one nanosecond width) can be used to accurately determine a distance. The high bandwidth (e.g., 500 MHz of spectrum) allows the narrow pulse and accurate location determination. A cross correlation of the pulses can provide a timing accuracy that is a small fraction of the width of a pulse, e.g., providing accuracy within hundreds or tens of picoseconds, which provides a sub-meter level of ranging accuracy. The pulses can represent a ranging wave form of plus 1's and minus 1's in some pattern that is recognized by a receiver. The distance measurement can use a round trip time measurement, also referred to as a time-of-flight measurement. As described above, the access device or mobile device can send a set of timestamps, which can remove a necessity of clock synchronization between the two devices.

### II. Directionality Based Access

Access devices (e.g., smart locks) may provide access to a location based on a mobile device (e.g., a smartwatch, a smartphone, or a mobile phone) approaching the access device. Access devices may often be limited in terms of available energy (e.g., a finite battery size). Thus, “brute force” or “constantly on” approaches (e.g., constantly monitoring for a radio signal (e.g., Bluetooth, Wi-Fi, UWB) between the access device and the mobile device) lead to substantial battery drain and degrade the usefulness of such devices.

Additionally, even with constant communication between the devices, such monitoring does not indicate the directionality of approach to the access device. For example, in cases where an access device should only provide access when approaching the device from one direction, existing techniques fall short. For example, if approaching a smart-lock from the outside of a house, the smart-lock may be configured to unlock. However, if approaching the smart-lock from the inside (e.g., during access within a house or dwelling), it may not be desirable for the smart-lock to be unlocked for security reasons.

As further discussed below, embodiments of the disclosed technology may address these limitations.

### A. Example Smart Lock System

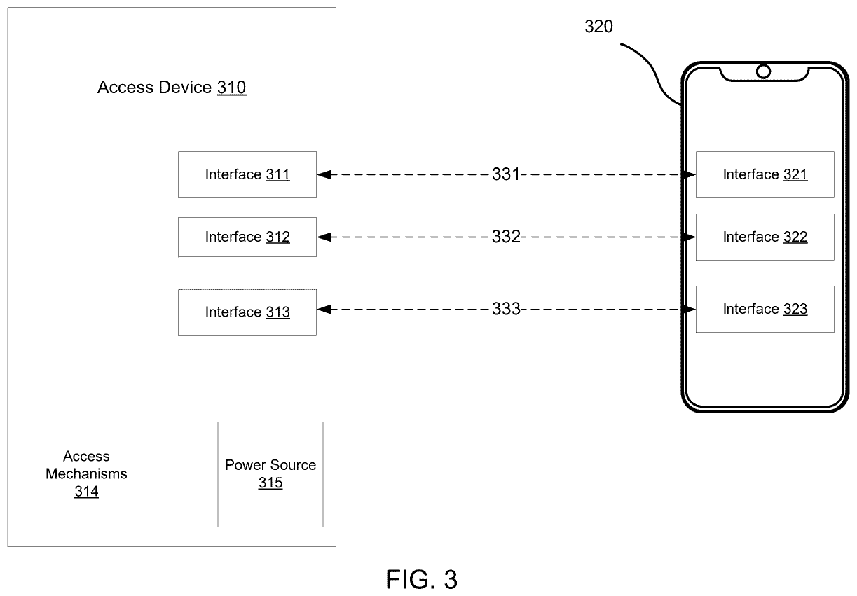

FIG. 3 illustrates a system 300, which may include an access device and mobile device according to embodiments of the present disclosure. Illustrated in FIG. 3 is an access device 310 and mobile device 320.

Access device 310 may include technology that may be used to restrict or control access to a specified location. Access device 310 may include turnstiles, electronic gate systems, secure entry doors, and smart locks. Smart locks may refer to devices that lock and unlock responsive to a command to lock or unlock. Access device 310 may include the capability to automatically lock and unlock as a mobile device 320 approaches access device 310. Access device 310 may function without user intent-based interactions, such as tapping a phone or using a wearable device to interact with an application to cause an unlock or access to be granted by access device 310.

Access device may include various wireless communication interfaces, such as interfaces 311-313. Each communication interface may differ in range, energy consumption, latency, and communication protocol used. For example, interface 311 may be a Bluetooth interface, which may also support standard Bluetooth and Bluetooth Low Energy (BLE). Interface 312 may be a Wi-Fi interface. Interface 313 may be an UWB interface. As further explained herein, interfaces 311-313 may be used at different stages of approach by mobile device 320 to enhance access provided by access device 310. Other interfaces may be included such as near-field communication (NFC) devices. Communication with the various interfaces described of access device 310 may be initiated sequentially, such as from an interface with the lowest power threshold to the highest power threshold. This may allow for power savings to be achieved by access device 310.

Mobile device 320 may also have interfaces 321-323, which may be similar to interfaces 311-323 respectively. Each interface may allow for a wireless signal to be sent between the respective interfaces. For example, wireless signal 331 may be a Bluetooth signal sent between interface 311 and interface 321. Wireless signal 332 may be a Wi-Fi signal sent between interface 312 and interface 322. Wireless signal 333 may be an UWB signal between interface 313 and interface 323.

The directionality of approach of mobile device 320 to access device 310 may affect the behavior of access device 310. For example, access device 310 may only unlock when approaching from a first side (e.g., from outside a house) versus a second side (from inside a house). Referring to interfaces 311-313, at least one interface may be an interface that allows for directionality of approach to access device 310 to be determined, such as differential signal strength. For example, referring to interface 313 (which may be an UWB interface), directionality may be determined by differentiation in physical sensors on a first side of access device 310 as compared to a second side of access device 310. For instance, interface 313 may contain a larger number of sensors on a first side of an access device as compared to a second side of the access device. In various embodiments, directionality may be built into interface 313. Additionally, the difference in signal strength when mobile device 320 is at a first side or a second side may be used to determine which side mobile device 320 is approaching access device 310 from.

Access device 310 may also have one or more access mechanisms 314 that control mechanical components of access device 310. These access mechanisms 314 may be used to provide access to a specified area (e.g., the interior of a home, a public transit system, an office space). The mechanical components to secure an area (e.g., locking a door) may include an electrically controlled bolt that interacts with a door frame to secure a door. The bolt may be actuated by a motor that receives signals to lock and unlock a door. In various embodiments, the mechanical components may comprise other motors and/or locks to prevent a turnstile from turning or to cause an electronic gate to open by sliding or rotating doors.

Access device 310 may also contain a power source 315 (e.g., a rechargeable battery or fixed alkaline or lithium-ion battery). Although in various embodiments, access device 310 may be powered through an external power source, in cases with an internal power source (e.g., a smart lock at a home, apartment, or other dwelling), power management may be important. Due to the size of the access device 310, the power source may be limited, increasing the need for intelligent power consumption and optimization by access device 310. Additionally, due to the number of times access device 310 may be used in a day, the need for power optimization is increased.

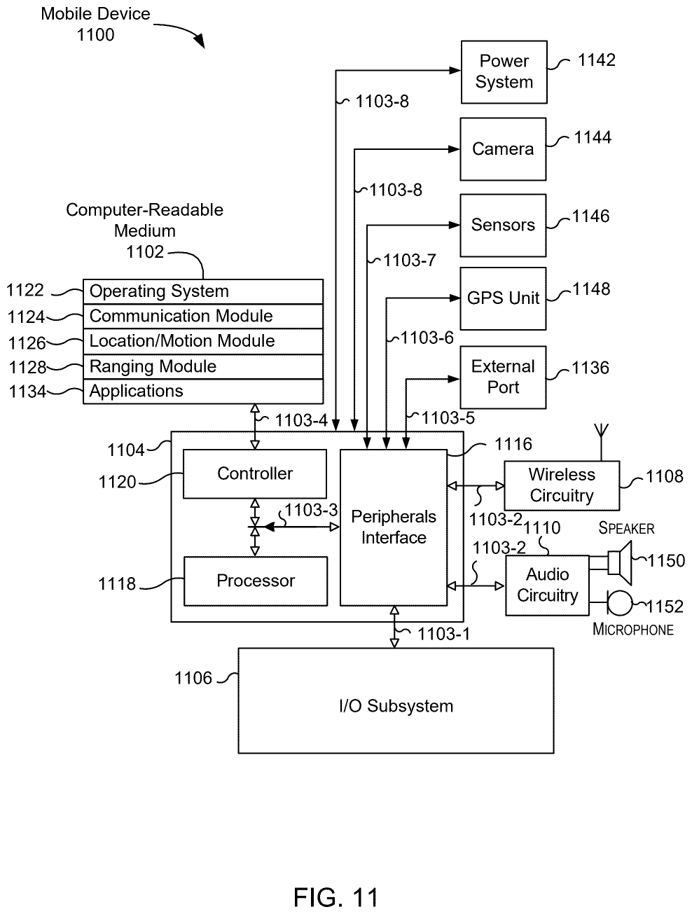

Mobile device 320 may be a smartphone, a mobile phone, a smartwatch, a SmartTag, smart glasses, headphones, or similar devices which contain communication, authentication, and processing abilities to communicate with a smart lock. In various embodiments, mobile device 320 may contain any combination of features and functionality described below with respect to electronic device 1100 described below in FIG. 11. Mobile device 320 may contain a number of components, including a processor, an accelerometer, a gyroscope, a light sensor, volatile and non-volatile memory, communication interfaces, and location sensors (e.g., a GPS sensor).

As further explained below, mobile device 320 may cause access device 310 to provide access as mobile device 320 approaches access device 310.

### B. Dynamic and Approach Based Access with Power Optimization

Described below is a process through which unlocking or access may be provided as a mobile device approaches an access device.

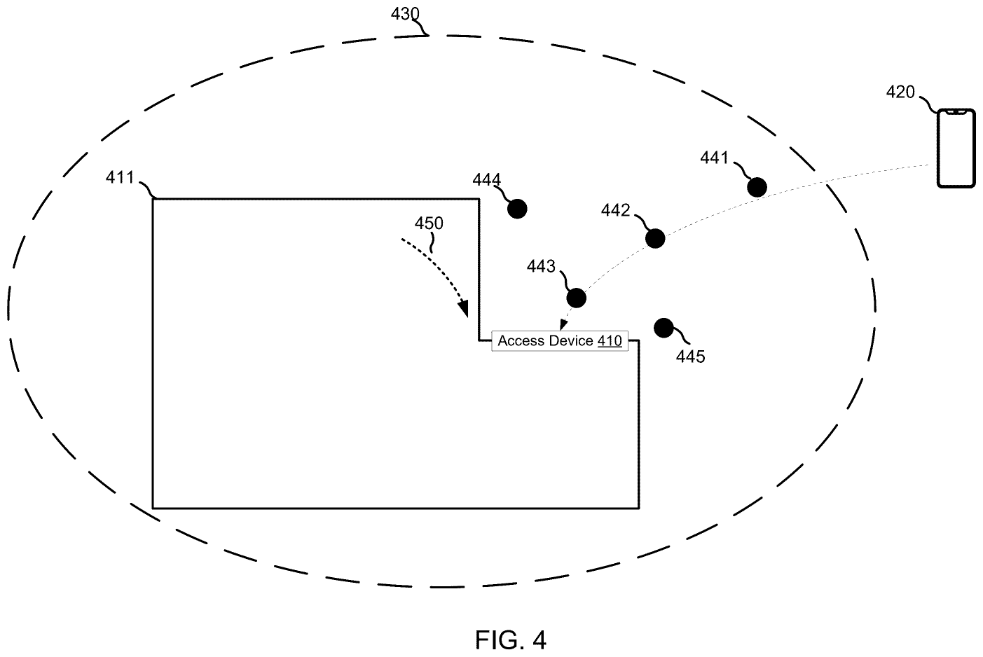

FIG. 4 illustrates a two-dimensional view 400 of an access device 410 installed on a dwelling 411, a mobile device 420, a geofence 430, and a series of locations 441-445 in which mobile device 420 may be located. Access device 410 and mobile device 420 may be similar to access device 310 and mobile device 320 described above with respect to FIG. 3. Also illustrated is an unlabeled arrow showing a potential direction of travel as mobile device 420 approaches access device 410 when the mobile device is within dwelling 411. This approach is discussed below to illustrate how differential signal strength from antennas may be used to distinguish between different paths toward the access device 410, and ensure that the access device only unlocks when the mobile device is sufficiently close to, on the correct side of, and generally within a zone of access device 410.

Geofence 430 may be a virtual perimeter or boundary defined around a specific geographic location using GPS, Radio Frequency Identification (RFID), or other techniques to determine location. Geofence may be generated as a radius around a point location, such as a radius around access device 410, or through a custom defined boundary (e.g., only one side of a house or dwelling from which a user would approach dwelling 411). Geofence 430 may be accessed through or stored in the memory of mobile device 420.

Following determination of crossing geofence 430 by a mobile device 420, a mobile device may attempt to connect to an access device through a first communication interface. This may occur at, for example, location 441 which is inside geofence 430. For example, the first communication interface may be a low energy source communication interface, such as Bluetooth. The access device may authenticate and identify the mobile device based on a prior pairing request. After initiation of the Bluetooth communication, the strength of the Bluetooth signal between access device 410 and mobile device 420 may be monitored by access device 410 or mobile device 420. As mobile device 420 approaches towards the access device 410, the strength of the Bluetooth signal is expected to increase in a predictable manner. The change or increase in signal strength can be used to determine if mobile device 420 is approaching access device 410. As one example, the signal strength may be measured using a Received Signal Strength Indicator (RSSI) metric to indicate the power present in the Bluetooth signal between the devices. This may act as a precursor to unlocking a door or to dynamic scanning using an additional signal.

The sampling rate of the Bluetooth signal may also increase as the RSSI metric for the Bluetooth signal increases. The increase in signal rate as RSSI metrics increase may decrease the latency in data collection processes and decision-making processes by the access device 310. In various embodiments, upon detecting no change or less than a threshold percentage change with the RSSI metric over a period of time (e.g., less than a 5% change over 5 seconds), the frequency of Bluetooth signaling may be decreased or default to a base value to preserve power. Upon a threshold change to the RSSI metric, the Bluetooth signaling rate may change or increase.

After the Bluetooth signal strength reaches or crosses a threshold, an additional signal can be used to determine the proximity between access device 410 and mobile device 420. The threshold strength may correspond with a point or distance from access device 410, which would allow for a second signal to be analyzed and used prior to providing access by access device 410. This may be, for example, location 442. For example, additional communication interfaces and techniques can be used, such as UWB or the use of ranging techniques described above with respect to FIGS. 1-2. As a user approaches a device, the Bluetooth signal as well as a secondary signal (e.g. UWB signals) or ranging techniques may be used.

As mobile device 420 is moving from location 442 towards the access device 410, the secondary signal may also be used to determine if the mobile device is sufficiently proximate to the access device to cause an unlock. For example, if the secondary signal is a UWB signal, a threshold distance may need to be reached to cause the access point to provide access. In various embodiments, ranging techniques can be used to determine that the distance between the mobile device 420 and access device 410 is less than a threshold distance. The point at which the access point initiates an unlock or grants access may be location 443. In various embodiments, location 443 may be customized or modified by or set by a user based on his or her preferences. In various embodiments, system defaults may be used to determine a threshold distance.

Additionally, access device 410 may be configured to only allow the lock to unlock from a first side of the access device and not a second side of the access device. For example, access device 410 may only unlock when the mobile device 420 is approaching the access device from outside dwelling 411 and not when the user is inside dwelling 411. To facilitate this, directional antennas may be used with UWB or other technology to determine if the mobile device 420 is on the first side or second side of the access device (e.g., whether the mobile device is on one side of the other side of the door). The use of directional antennas may be used to provide a differential RSSI for each of the directional antennas included. In various embodiments, the usefulness of the differential RSSI may be enhanced through measuring the differential over time or through the use of machine learning behaviors to determine which side. In various embodiments, certain access devices will have inherent directionality (e.g., a smart lock that has an outside and inside face). In such cases, it may be known by the smart lock which “face” of the smart lock is the inside face and which is the outside face. This information may be used by the smart lock to further determine whether or not to provide access.

Additionally, the use of directional antennas may be used to further distinguish in cases where dwelling 411 may be of a shape wherein access may be non-standard. For example, in an “L” shape house, motion within a specific area of the house may make it appear as if a user is approaching the access device. For example, with respect to FIG. 4, one such path has been labeled as 450. Path 450 may also improve RSSI strength but due to directionality of antennas, it may be determined that the mobile device is not in front of one face of the smart lock, but rather to a side of the smart lock. Another similar occurrence may happen when a bedroom is above the smart lock or a basement area is below the smart lock. Directional antennas may indicate that the mobile device is “above” or “below” the smart lock, and in these cases, an unlock message will not be sent by the mobile device or generated by the smart lock.

In various embodiments, the pattern of RSSI signals over time may be stored as a signature for an approach that a mobile device 420 takes in approaching access device 410. This signature may be compared against a set of data indicating the path taken in cases where Bluetooth and/or UWB signals indicate that a user is within proximity to the access device 410 but has taken a different path or approach to access device 410. For example, when a user with a mobile device 420 is above access device 410 (e.g., in his or her bedroom), this signature information may be used. As another example, a user may be pacing in an area of his house which similarly increases RSSI signal strength and indicates proper directionality based on differential RSSI strength. Comparison with a stored signature may thus avoid providing access when the pattern of signal strength during an approach to the access device differs by more than a threshold from a stored pattern of signal strength.

In various embodiments, the RSSI is expected to increase in a consistent manner. Thus, approach patterns which are not consistent with a substantially approach (e.g., a zigzag or half-hazard approach towards the access device) may cause access device 410 to not provide access or require additional steps for unlocking the door. For example, the RSSI may be expected to increase as a substantially monotonic function with time. Additionally, in various embodiments, the RSSI may increase to a certain level, but then decrease, such as when a user is walking past access device 410 but not entering the device. In these examples, the use of a secondary, or even tertiary signal, ensures that only mobile devices 420 which are approaching the access device 410 in a consistent manner will be provided access.

Additionally, in various embodiments, when the RSSI has not increased in a period of time, or the unlocking process has not been completed within a set of time, access control mechanisms may be “timed out” and deactivated.

In various embodiments, the above configuration may be adapted or further refined to characterize the use of a particular mobile device towards access device 410. Thus, the door will only unlock if a user is approaching the door from the outside. This is further enhanced by machine learning algorithms or other pattern recognition techniques that learn from user behavior patterns, improving the predictive accuracy over time. For example, a pattern of a person walking directly to the front door at a time after work can be used as a further input to more quickly resolve the user intent to enter the front door. Such an additional feature can be used in combination with the other signals described here, such as motion data, signal strength, and range.

While the above-discussed approach may reduce computational time and energy consumption as compared to an “always on” approach, there still may be significant battery drain when a user is near access point 410 but not actively approaching the access point. Such examples may include points such as locations 444 or 445. Location 444 may be a location where a user possessing mobile device 420 is on his or her porch, that is near access device 410 but does not intend to access the device. At this location, the mobile device 420 may be relatively stationary (e.g., when a user is sitting on furniture on a porch). At location 445, the user with mobile device 420 may be moving but not approaching the access point 410. This may be a location where the user is gardening or a similar approach. Additional improvements to the disclosed technology are further discussed below.

### C. Modification of Unlocking Based on Motion Classification and Micro-Locations

As discussed above, modifications to door unlock may provide additional benefits to power consumption, usability, and reduction of processing time. However, in some examples, additional classifications may further provide additional power savings and reduction in processing time. For example, in situations such as watering plants, performing gardening work, moving inside the house, taking a walk around the house, or performing maintenance on a house, signal strengths may change without a user or mobile device attempting to access an access point through an access device.

As further outlined below, motion classifiers and other devices may be used to modify the communication between a mobile device and an access device. This process may take place on a mobile device through the use of various sensors.

### 1. Motion Classifier to Modify Access Control Mechanism

A mobile device may include a motion classifier module which can be used to determine the state of the mobile device. Based on a classified state, the rate of ranging (ranging rate), the active communication interfaces, and whether or not an access device may provide access can be modified.

In various embodiments, the motion classifier may be a classifier which provides a stationary classification or a moving classification (which may also be referred to as a displacing classification). The motion classifier need not detect activity in terms of walking, running, or a fitness activity but only classify the activity as detecting displacement. This motion classifier may thus be a more efficient model. In various embodiments, the motion classifier will only activate upon crossing a geofence, such as geofence 430 described above.

Upon determining a stationary classification, such as when a user remains inactive for an extended period of time (e.g., above a threshold period), the mobile device may suspend all access related operations to converse energy and reduce unrequired signaling. However, upon determining a moving classification, the system may enable access control mechanisms described herein.

In various embodiments, the motion classifier module may include inertial odometry data as input data to determine a stationary state or a movement state. Thus, when a user remains stationary for a threshold period of time (e.g., 5 minutes), access control mechanisms described herein may be paused. In various embodiments, upon detection of activity after a period of time, followed by another classification that is stationary may require the threshold period to decrease. Example inertial odometry data which may be used includes inertial sensor data such as gyroscope data and accelerometer data.

As an example, the motion classifier module can determine whether movement exceeds a threshold within a given time period, and if so then the module can determine a movement state is present. Different thresholds can differentiate between different movements states, e.g., walking, running, biking, and driving, each with increasing values for the thresholds for the motion. As further examples, a moving average can be taken over time or a majority vote of recent time periods over a larger time interval, where the state classification of the time interval is determined based on the most common state determined for the time periods in a given time interval. In other implementations, a machine learning model can use various measurements, e.g., from an accelerometer, magnetometer, gyroscope, wireless network signals, and GPS.

Due to the low latency requirements for access control, the motion classifier module may also modify a threshold period based on the distance to an access device. For example, when a mobile device is closer to the access device, the mobile motion classifier module may provide a larger number of false positives or increase the threshold period for inactivity or to suspend access control mechanisms. If a mobile device is farther from an access device, the threshold period for access control may be decreased or a larger amount of motion may be required prior to enabling the access control mechanisms. Additionally, the type and timing of which communication interface which is deactivated may be based on the distance to the access device. For example, UWB communication may be turned off after a longer period of time when a user is closer to the access device. However, UWB communication may be turned off after a shorter period of time when a user is farther from the access device. In various embodiments, Bluetooth communication may be turned on for a longer period of time prior to being deactivated (even through signal strength is low and/or device is farther away as determined by a location technology) as it is less energy intensive than UWB communication.

### 2. Use of Microlocations and Simultaneous Localization and Mapping (SLAM)

Further, the disclosed technology may incorporate location-based technologies, such as the use of microlocations and simultaneous localization and mapping (SLAM) to further improve energy consumption and accuracy of the disclosed technology.

A location that refers to a specific area in a user's home can be referred to as a microlocation, which is measured using signals from signal devices that assumed to be stationary, such as a wireless router, thermostat, smart TV or compatible device, a smart speaker, etc.. Thus, a given location can have a unique combination of signals (e.g., range or strength) when three or more signal devices are used. A microlocation can also be referred to as a cluster of locations. The following terms: location, microlocation, and cluster of locations may refer to a same area or region. A location can correspond to a room in a house or other areas in a house. For example, a location can be a backyard area, a front door area or a hallway area. Although a home is used as an example, any area or room in which accessory devices are located can be used in determining a cluster of locations.

SLAM techniques can be used to build a map of the environment (e.g., the bedroom) and localize the user in that map at the same time. SLAM algorithms allow the mobile device to map out unknown environments. Various SLAM techniques may be used by the mobile device to enhance the accuracy and functionality of the techniques described herein. For example, the mobile device may use Visual SLAM (or vSLAM) by acquiring images from cameras and other image sensors. The mobile device may use simple cameras (e.g., wide angle, fisheye, and spherical cameras), compound eye cameras (stereo and multi cameras), and RGB-D cameras (depth and ToF cameras). vSLAM can be implemented at low cost with relatively inexpensive cameras, allowing it to be used on a variety of mobile devices. In addition, since cameras provide a large volume of information, they can be used to detect landmarks or previously measured positions. Monocular SLAM is when vSLAM uses a single camera as the only sensor, which makes it challenging to define depth. This can be solved by either detecting AR markers, checkerboards, or other known objects in the image for localization or by fusing the camera information with another sensor such as inertial measurement units (IMUs), which can measure physical quantities such as velocity and orientation. Technology related to vSLAM includes structure from motion (SfM), visual odometry, and bundle adjustment. The mobile device can use SLAM techniques to distinguish between the inside and the outside of a house or other areas to be accessed. In various embodiments, the SLAM technique may also include a visual representation of the smart lock or other access device when a camera is available on a mobile device for the unlock functionality described above.

Microlocations can be determined by a mobile device. The mobile device may identify applications or accessory devices that correspond to a location within a house. Additionally, for each position, sensor data and sensor positions may be collected with respect to an access device and other accessory devices within a house. After collecting sensor positions and corresponding actions taken by a user or run by the user at the sensor positions, the device may generate clusters of sensor positions (e.g., periodically at night). This information may be associated with one or more applications that are likely to be run by the user with the clusters of sensor positions, which may also be used by the mobile device in determining whether or not the mobile device is inside or outside a building (or on a first side or second side of an access device). Accordingly, when a subsequent triggering event is detected, the device may generate a new sensor position and compare the new sensor position to the generated clusters of sensor positions. If the new sensor position is determined to be within a threshold distance to one of the clusters of sensor positions, one or more applications associated with that cluster of sensor positions may be identified and used in an action, e.g., provided to the user as a suggested application. The threshold distance may be a distance represented in units of decibels (e.g., for received signal strength indication (RSSI)) or meters (e.g., for time-of-flight (TOF)), depending on the units of the sensor position, as will be discussed further herein. The mobile device may use the location information to determine a relevant playback device of a plurality of playback devices at a location.

With respect to an access device, the use of microlocations and SLAM may further increase the certainty of providing access through an access device. For example, if microlocations indicate that a user is within his or her house, all ranging and access control mechanisms may be terminated. Additionally, SLAM may be used to verify or determine that a user is approaching his or her home, and the access device, from a certain location or area. Additionally, microlocations and SLAM related information may further provide information about locations which are within a geofence but in which a user is unlikely to approach his or her door (e.g., a garden, a garage, or a porch). Additionally, other devices being interacted with may further provide. This information may be used in conjunction with the motion classifier described above to modify the access control mechanisms, including ranging and sensor rates, as described above.

In various embodiments, the probability of a mobile device being at a particular location of interest (e.g., a location at which a door unlock would be desirable) can be determined based on microlocations. Whether or not to initiate ranging and changing sensor rates can be based on the probability and confidence of a mobile device being at a particular location.

### D. Method for Directional Unlocking

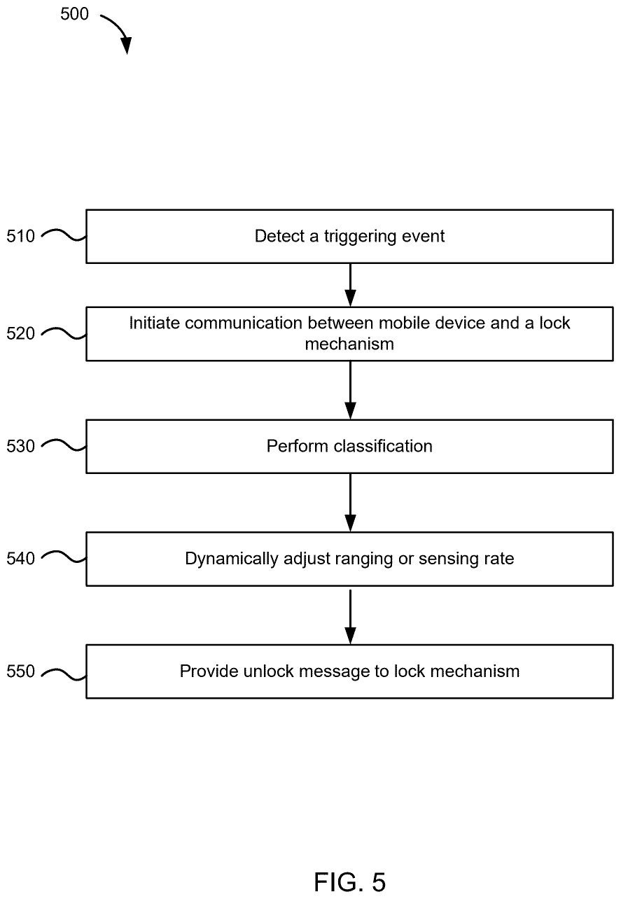

FIG. 5 is a flowchart of a method 500 for access control. Method 500 is performed by a mobile device seeking functionality from an access device. A corresponding set of steps are performed by the access device.

At block 510, a triggering event may be detected. A triggering event may be a mobile device crossing a geofence towards a location. For example, a mobile device may be moving towards a house. The mobile device may then cross a geofence. Determination of whether or not the mobile device has crossed a geofence may be based on location-based sensors (e.g., a GPS sensor included within the mobile device).

In response, the access device may determine a triggering event based on detecting a mobile device is within a predefined distance from the access device. For example, in some cases the mobile device may not determine that it has crossed a geofence. The access device may determine that the mobile device has crossed the geofence and/or is within a distance at which communication can be established between the access device and the mobile device. These may be examples which may be detected trigger events. In some examples, a notification of the triggering event may be transmitted to the access device.

At block 520, communication may be initiated between a mobile device and a lock mechanism. The lock mechanism may be an access device. The communication process may be initiated by the mobile device in attempting to connect or pair with the lock mechanism. The communication process may be initiated using a wireless protocol. The choice of wireless protocol may be based on energy consumption and accuracy requirements.

In response, the mobile device may transmit a first communication request to the lock mechanism (or other access device). In some examples, the lock mechanism may initiate the communication between the mobile device and the lock mechanism through any of the interfaces described above, such as for example, interfaces 311-313. In some examples, the lock mechanism may

At block 530, a classification can be made of the mobile device as moving towards the predefined location based on the wireless signals of the wireless protocols received from the lock mechanism. In various embodiments, this classification may be updated or modified based on other techniques or information, such as sensor fusion, use of microlocations, or visual information from visual SLAM. Accordingly, classifying the mobile device can be based on sensor data from sensors of the mobile device.

In response, the lock mechanism may receive or make this determination based on information it obtains from the mobile device, or signal data from one or more communication protocols between the mobile device and the lock mechanism.

At block 540, the ranging rate with the lock mechanism may be dynamically adjusted. This may be based on the wireless signals received. The dynamic adjustment of the ranging rate, or other wireless signals received, may be based on various criteria. In various embodiments, the adjustment of the ranging rate may be performed by either the lock mechanism or by the mobile device. In various embodiments, the ranging rate may be based on threshold signal strengths or increase as a function of signal strength. In other examples, a motion classification may determine the ranging rate.

In response, the ranging rate may be set or established by the lock mechanism. For example, the lock mechanism may establish a maximum ranging rate based on the distance between the lock mechanism and the mobile device. In other examples, the lock mechanism may establish a variable ranging rate for one of the communication protocols based on a signal strength.

At block 550, an unlock message can be provided to the lock mechanism. In various embodiments, the unlock message may indicate a range between the lock mechanism and the mobile device. In other examples, the unlock message is provided from the mobile device to the lock mechanism. The unlock message may be provided from the mobile device to the lock mechanism through a communication protocol that has already been established between the mobile device and the lock mechanism.

In various embodiments, unlocking can occur at the lock mechanism when the lock mechanism determines that the distance between the lock mechanism and the mobile device is less than a specified distance. In some examples, in response to a mobile device being sufficiently close, the lock mechanism may generate an unlock message which may be sent the mobile device for verification or identification of the mobile device, and then returned from the mobile device to the lock mechanism.

### III. Fast Entry

There is often latency when a mobile device enters a geofenced area. This may be due to delays in signals, signal processing, tradeoffs in accuracy and speed, and verification by other data (e.g., a known wireless router) to ensure that the mobile device has entered the geofenced area. This latency may lead to delays in actions which are configured to be taken responsive to the entry of the mobile device into the geofenced area. Examples of such actions may include, turning on lights, activating climate control, or other sequences of actions which may be taken by smart home devices or the mobile device. This may lead to a sub-optimal user experience.

Additionally, there may be multiple geofenced areas or areas of interest towards which a mobile device enters. Different actions may be performed depending on the geofenced area entered by the mobile device. Thus, improved and contextually aware actions requires not only high classification accuracy but low latency.

One solution to improve latency is increasing the rate at which the location of a mobile device is obtained. However, this is a power intensive process that is impractical for the limited energy capacity of mobile devices. This further may not identify which of multiple geofenced areas or points of interest the mobile device is approaching.

Thus, there is a need to improve the latency between a mobile device entering a geofenced area and recognition that the mobile device has crossed the geofenced area while simultaneously considering the power consumption and energy storage limitations of mobile devices.

As explained below, various embodiments related to “fast entry” may be used to reduce or eliminate latency when a mobile device enters a geofenced area and minimizes the detection period in which the mobile device is recognized as having entered the geofenced area (e.g., a less than five second entry detection from the point at which the mobile device has crossed into the geofenced area).

In various embodiments, fast entry can enable additional contextual information to be provided or events to occur based on the improved latency detection provided by various embodiments of the disclosed technology. For example, with respect to a particular place of interest (e.g., a coffee shop), various contextual information can be provided on the mobile device or to an operator of the place of interest (e.g., coupons, promotions, or deals of the day).

In other examples, the operator of a commercial place of interest can be provided with information that can be obtained based on the various embodiments below and assist with enhancing service for a user. As one example, based on determination that a user is approaching a coffee shop and has placed an order, the coffee shop may be provided with information from a mobile device which indicates that the user has crossed a geofence related to the coffee shop and can bring his or her order to an area of the coffee shop for pickup.

As further explained below, a directional motion classifier may be used to modify a rate of collection of location data from a mobile device. The proximity classifier may determine whether the device is in a “near” state or a “far” state to a location of interest. A directional motion classifier may also determine whether the mobile device is approaching a location of interest, and may cause the rate of collection of location data from the mobile device to increase as the classifier determines that the mobile device is likely approaching the location of interest.

### A. Proximity Classifier

A proximity classifier may be a classifier which may determine whether or not a device is in a “near” state or a “far state” with respect to one or more locations of interest. In one example, the classification may be in a “near” state when the mobile device is within a geofence (e.g., a geofence which is larger than and encompasses a geofence that determines that a device is at a location of interest when crossed.)

The classification of whether a device is a near state or a far state with respect to a location may be based on multiple inputs, including for example, metrics which relate to the size of the geofence for an area of interest, the distance of the mobile device to a boundary of the geofence, the number of geofences within an area, the density of multiple geofences, fingerprinting based on Wi-Fi signals or other signals in a known geofenced area, or probable time to reach a geofence based on current speed or velocity. For example, the distance to the geofence may be used for a classification which relates to a multiple of the size of the geofence. In another example, the classifier may use historic data related to distance, speed, and/or time to the geofence from a trailing period of time (e.g., the last 15 seconds) to determine if the device is in a “near” or “far” state from the geofence.

In some examples, the classification can be made based on a probability measure. For example, to determine a probability measure, a moving average of distances to a geofence can be used and one or more functions can be applied to provide a probability metric which relates to the “nearness” or “farness” of the mobile device to a geofence. A threshold may be used to determine if the probability is above or below the threshold state.

In some examples, a multiple of the size of the geofence can be established. For example, for a two-dimensional geofence, a centroid point may be determined, and a mobile device may be classified as “near” the geofence if it is within a multiple of the average distance between the centroid and the boundary of the geofence. In some examples, the threshold for determining nearness may depend on the latency of other functions in the mobile device. If latency for a particular device is low with respect to location measurements, then the mobile device may have a higher threshold (e.g., a higher probability requirement) to be in a “near” state. This may further improve energy or battery savings.

In some examples, a classifier may change the behavior of the mobile device based on the “near” and “far” state. For example, the base rate of GPS requests or other location request may change based on the state determined by the classifier. In some examples, a mobile device may be in a “near” state to multiple geofences based on a threshold probability.

### B. Directional Motion Classifier

As further discussed below, the directional motion classifier may provide an output of whether the mobile device is approaching a location, geofence, or point of interest, and the speed or velocity of approach. This may be based on information obtained from location data as well as from sensor data. The directional motion classifier may be used to increase the rate of location data obtained the mobile device.

### 1. Overview of Classifier

As further explained below, a directional motion classifier may be used to modify a rate of collection of location data by a mobile device. In various embodiments, the directional motion classifier may be used after determining that the mobile device is in a “near” state. The directional motion classification may be suspended if the mobile device is determined to be in a “far” state. The directional motion classifier may determine whether the device is approaching or towards the direction of a location of interest. When a device is in a “near” state with respect to a point of interest or a geofenced area (e.g., based on an output from a proximity classifier), the directional motion classifier may initiate techniques to increase the amount of location data collected by the mobile device. As the directional motion classifier may have additional location data as the mobile device enters into a geofenced area, it can decrease the latency in the mobile device being recognized as having entered the area. Thus, actions can be taken in a manner which appear seamless to a user of the mobile device. For example, if a coffee shop is being approached and the geofence of coffee shop is breached, the mobile device may present coupons or promotions for display on the mobile device with low latency. The latency is decreased as compared to waiting for confirmation that the mobile device is in the geofenced area.

A directional motion classifier may be used to determine probable states of approach of a mobile device towards a point or area of interest or a geofenced area. The geofenced area may be, for example, a house, an office, a commercial building (e.g., a restaurant or coffee shop), a park, an area representing a state line, or other geographical boundaries.

In broad overview, the directional motion classifier may determine whether a mobile device is trending towards an area of interest, and whether it is in, for example, an approaching state, with respect to an area of interest. The classifier may first identify the area of interest based on proximity, weighted directionality of travel (e.g., such as during the last five minutes), historical travel patterns for the mobile device (e.g., such as based on time of day, frequently visited areas from the current location of the mobile device, or other context specific information). During the approach, the classifier may classify the state of the device with respect to the distance and/or directional of travel of the mobile device to the area of interest. In various embodiments, a value from a list of values may be used to represent the direction of travel or closeness of the device to a point of interest. In other examples, a positive real number may be used to represent the “nearness” and be provided as an output for the directional motion classifier. This number may then be translated or converted into a class which can affect the sensing rate of the mobile device.

Additionally, the activation or use of the classifier may be based on policies and contextually aware clues. For example, the classifier may have a time-out function which may indicate that a threshold change in approach or nearness has not occurred within a predefined period of time. The time-out period may differ based on the distance to the area of interest. For example, if a user and his or her mobile device is near the user's home (e.g., a neighbor's home), but has not met the threshold change required, the mobile device may be deemed to not be approaching the geofenced area associated with the user's home. As another example, during an approach home, the classifier may be deactivated if a mobile device is deemed to be paused, the average velocity is not high enough relative to the distance to the area of interest, or average velocity or speed within a predefined period is lower than a threshold amount.

In various embodiments, the classifier can pause, suspend, or delay GPS tracking or other location services if it becomes aware that the mobile device will not approach the area of interest for a period of time based on contextual information, such as speed limits, possible paths to the area of interest, or current traffic conditions, to reduce power consumption.

### 2. Example Classifiers, Inputs, and Outputs

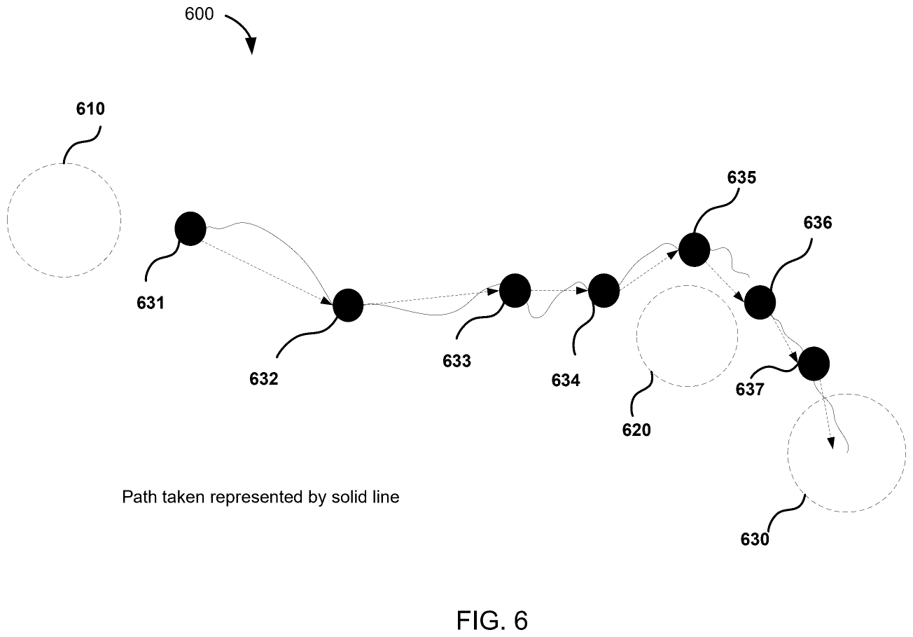

As described above, in broad overview, the directional motion classifier may determine whether a mobile device has trended from a far state to a near state or an approaching state with respect to an area of interest. An example use of the classifier is explained below with respect to FIG. 6.

The directional motion classifier may include unsupervised clustering techniques and supervised clustering techniques. The directional motion classifier may incorporate visit monitoring through unsupervised clustering (or other unsupervised machine learning techniques) and region monitoring via supervised learning techniques. Visit monitoring may employ unsupervised clustering algorithms to automatically detect and notify when an individual enters a specific location without prior labeling or categorization of data. This feature is designed to function through identifying patterns and clusters within the location data to signal an entry event. For example, closely bundled GPS locations over a period of time may indicate an area of interest which may be identified or labeled through an unsupervised clustering technique. A particular physical location associated with the identified area of interest need not be known, which may be assigned or derived solely based on location data.

Supervised region monitoring component operates on pre-defined geographical boundaries. Users can specify particular areas for which they wish to receive entry and exit alerts. This technique may utilize supervised learning to accurately recognize and confirm a user's mobile device within these controlled zones, enhancing the ability to learn. Defining these geofences or other geographical boundaries may allow for a higher accuracy and ability for the directional motion classifier to learn.

The directional motion classifier may include a displacement model that can use sensor values from inertial measurement unit (IMU) sensor(s) to determine the change in position of the mobile device as the device moves within a physical environment. In some embodiments, the position can be the position of the body of a user of the mobile device. As examples, the sensor values output by the IMU sensor can be a direction of gravity relative to the mobile device, an acceleration in a vertical plane parallel to gravity, acceleration in a horizontal plane perpendicular to gravity, a rotation (e.g., yaw) of the tracking mobile device, a pitch of the tracking mobile device relative to gravity, a roll of the tracking mobile device relative to gravity, gyroscope readings (e.g., rotational acceleration readings), and a compass (e.g., magnetometer) reading. The displacement model may provide a prediction or an output which relates to the change in position calculate by the displacement model, which may be used by the directional motion classifier in classification of an estimated or new position.

In various embodiments, the directional motion classifier may utilize sensor values output from the IMU sensor that is input to the displacement model and/or the directional motion classifier, including linear acceleration (e.g., one or more of the horizontal and vertical acceleration), rotational acceleration (e.g., acceleration around one or more axes), and magnetometer readings (e.g., magnetic field measurements along one or more axes). The displacement model can use this input to calculate a displacement (e.g., a net change in position over a time period) of the mobile device. For example, the displacement model may take the second integration of an acceleration measured by the IMU sensor(s) to determine the displaced distance, and the rotational acceleration and magnetometer readings can be used to determine the displacement's change in orientation. The first integration of the acceleration can produce velocity and the second integration of the acceleration can produce the distance. The displacement model can use a magnetometer reading to determine the orientation of the mobile device at each calculated position. The model may separately determine location and orientation, and, in some embodiments, the displacement model may include a model for determining location and a model for determining orientation. The displacement can be a net change of two-dimensional or three-dimensional coordinates in any coordinate system (e.g., cartesian coordinates). In some embodiments, the displacement can include coordinates and an orientation relative to a reference direction (e.g., relative to magnetic north).

During an approach to a location, the directional motion classifier may cause the mobile device to perform a series of steps which can increase the accuracy of the location of the mobile device and allow for high-integrity location monitoring to be achieved. For example, a wireless (e.g., Wi-Fi) location request can be made as a location is being approached (e.g., at 500 meters). A Wi-Fi location request may only have a presumed precision of 50 to 100 meters, making it useful for a low energy request when the relative distance to the geofence is high compared to the precision of the geofence. A GPS, or other global navigation satellite system request, may have a precision on the order of a few meters. Thus, intelligently switching between a wireless network location request and a global navigation satellite system location request may provide power savings.

FIG. 6 illustrates a map 600 with a geofence 610, a geofence 620, a geofence 630, and various positions 631-637 which a mobile device may be present at as it moves on map 600. Geofences 610, 620, and 630 may define map areas, which may be user-defined or derived from clustering techniques as described above. Each position may be an estimated position for a mobile device which may be derived using GPS, wireless triangulation, wireless network circuitry, or other techniques. As explained below, a directional motion classifier may identify which geofence the mobile device is approaching, and modify requests made by the mobile device to enhance precision and accuracy of the location estimates of the mobile device while preserving the power used by the mobile device.

Each of positions 631-637 may be associated with a speed, direction, and/or velocity depending on the types of measurements which may be obtained at that point. This may include the IMU sensor data described above. Additionally, state data from the mobile device may be incorporated into the measurement. Positions 631-637 may be sequential positions in time. The path which is taken by a mobile device between the positions is illustrated in a curved line connecting the points. Vectors which are related to the positions are illustrated in straight dotted lines. For clarity, the vectors are not numbered in FIG. 6.

Position 631 may represent a starting point from which a mobile device may start to move. At position 631, the directional motion classifier may need to first make an estimation of which of the three identified geofences, 610, 620, and 630 the mobile device may be approaching. An initial estimation may be made on heuristics or historical data which may be known by the directional motion classifier, such as based on the starting position and time of the mobile device. At position 631, the proximity classifier may determine that the mobile device is in a near state to geofence 610 but in a far state from geofence 620 and geofence 630. At position 631, as the mobile device is in a near state, the directional motion classifier may also classify the mobile device as approaching geofence 610.

Position 632 may represent a point at a time later at which the mobile device may move. At position 632, the mobile device may not be in a near state to any of geofences 610-630. The classification as being far from any geofence may be modify the behavior of the directional motion classifier. For example, the directional motion classifier may reduce the rate of GPS requests or other information based on the proximity classifier being in a far state. Position 632 may be measured at a fixed time after the measurement of position 631. In other examples, the measurement of position 632 may occur based on a time which relates to the speed or velocity of the mobile device. As illustrated in FIG. 6, position 632 is to the right of position 631, and represents motion towards both geofences 620 and 630. At this position, an estimated directionality may be determined for the mobile device based on a vector generated between positions 631 and 632, represented by an arrow between the two positions. Additionally, other information may be included. At position 632, the directional motion classifier may determine a low probability that geofence 610 is being approached and a higher probability that geofence 620 or 630 are being approached. However, these probabilities may be updated as directionality may change due to traffic, route, or other conditions. For example, a future position may indicate that geofence 610 is likely to be approached, and the directional motion classifier may update based on this information.

Position 633 may be a further position which is closer to both geofence 620 and 630. Another vector may again be generated based on position 632 and position 633. Other information, such as that described above with respect to the displacement model may be, may also be calculated or included in evaluating position 633. Based on this data, the directional motion classifier may determine that it is likely that geofence 620 or geofence 630 is being approached. Additionally, based on the estimated distance to either geofence 620 or 630, the directional motion classifier may increase the rate of a sensor measurement. At this point, based on the distance to geofence 620 or 630, the directional motion classifier may initiate a more frequent wireless location request (e.g., every minute). The frequency of the location request may depend on the distance to either geofence 620 or geofence 630.

At position 634, it may be determined that there is a high probability that the geofence 620 is being approached. This may be based on a vector between position 633 and position 634. This vector may be more weighted based on the proximity of the start and end points of the vector to geofence 620. If position 634 is within a fixed distance of the boundary of geofence 620 (e.g., within 500 meters), the directional motion classifier may transition from a wireless location request to a GPS request. At position 634 it may be determined that the mobile device is in a near state to geofence 620. At position 634, the mobile device may not be in a near state to geofence 610 or to geofence 630.

At positions 635, 636, and 637, as the mobile device approaches closer to the geofence, the frequency of GPS requests may increase. For each of position 635-637, a proximity classification can also be established for each of the positions. For example, at position 635, the mobile device may be in a near state with respect to geofence 620 but in a far state to geofence 610 and 630. At position 636, the mobile device may be classified as being in a near state to both geofence 620 and geofence 630, but in a far state to geofence 610. At position 637, the mobile device may be classified as being in a near state to geofence 630 but in a far state to geofence 610 and 620.

Additionally, with respect to the displacement model and the directional motion classifier, the motion classifier may change or modify the frequency of GPS rates. For example, in moving from position 634, to 635, and 636, the displacement model may identify that there is change away from the approach that may have been indicated in moving from position 633 to 634 (which may have indicated that the mobile device is approaching geofence 620). This is represented with the dotted line between position 634 and position 635.

For example, one-second GPS updates may be possible when the mobile device is estimated to be within a fixed distance (e.g., 10 meters) of the destination. This methodical escalation in location request frequency is designed to ensure precision and power efficiency in real-time tracking. Between these positions, a directional vector, and velocity estimates of the mobile device may be estimated. These estimates may be used by the directional motion classifier in determining a rate of GPS requests. The increased data and information near the geo-fence can provide a rich set of data for classification by the directional motion classifier.

Following position 637, the increased rate of requests may improve the determination that geofence 630 has been entered. Additionally, due to the increased frequency, the directional motion classifier, may determine whether or not the geofence is crossed over with a lower latency. For example, the directional motion classifier may use two or three location data points within the geofence to determine that the mobile device is within the geofence. This may reduce the number of false positives while providing a low latency in determining that a geofence has been breached.

Other cases, such as when a location is near a highway are discussed below, to further illustrate the use of the motion classifier in additional scenarios.

### 3. Training of a Classifier or Machine Learning Model

In various embodiments, training of the classifier can be performed based on obtaining output values for a set of tagging whether the mobile device has entered the geofenced area or not. In various embodiments, this set of data can be obtained based on global navigation satellite system, global positioning system (GPS), or other location data that has been obtained after the classifier determines the mobile device has entered the geofenced area. The collection of such data can be for a period of time following the determination by the classifier that the mobile device has entered the geofenced area. This can provide a set of data to the classifier which can enable the classifier to learn whether its classification was correct or not. In other examples, the output data can be based on identifying a Wi-Fi signal or source which is known to be within a specific geofence area. In other examples, the output values can be obtained based on a user interacting with the mobile device through a prompt (e.g., whether or not a particular action taken responsive to the classifier believing the mobile device is within a geofence was appropriate or useful).

In various embodiments, the input data can be the set of approach data, the rate of information requests, directionality, generated vectors, distance to a geofence, data related to the speed, direction, or velocity of approach, frequency rate, error estimates for each geofenced location, estimated time to arrive to the geofence, or other metrics or parameters derived from this data.

In various embodiments, the behavior of a classifier can be based on the historical or probable history of approach towards a geofenced area. For example, a classifier may use a different behavior of changing sensing rates depending on the type of errors associated with entry to a specific geofence (e.g., a geofenced location which is next to a busy street).

In various embodiments, both unsupervised and supervised clustering techniques may be used.

### 4. Examples of Potential False Classifications and Techniques to Reduce False Classifications

In various embodiments, a geofence may be near a highway, or other high-speed area, which may cause calculated vectors to indicate a direct path of approach to the area. For example, with reference to FIG. 6, geofence 620 may be a geofence which is located adjacent to a highway or other area. Yet, as illustrated in FIG. 6, it is possible that the mobile device continues on a highway (or other roadway or accessway) without entering the geofenced area. For instance, the mobile device moves from position 634, to position 635, and then to position 635, without entering geofence 620. In these situations, it is necessary to distinguish between motion which is coincidentally towards the geofenced area versus a true approach to the geofenced area. Another example may include a location which is immediately adjacent to a county road, such as a restaurant or drive-through location. In these examples, it may be useful to reduce the number of false positives by the classifier and distinguish between motion which is closer to the geofenced area.

One example of distinguishing such a movement may include the inclusion of a change over from a high-speed highways to an exit and other slower-paced side streets. This transition often presents a challenge in location-based services due to significant shifts in speed and travel patterns, which can affect the predictive accuracy of the system.

Another example may include the change of the size of a geofence and adapting the classifier when it classifies the approach as being towards such a geofence. In such examples, the frequency of the location request may be modified based on the calculated speed. For example, only a range of speeds may be possible for an approach towards a certain location (e.g., walking to a coffee shop, going to a drive through, arriving at an office parking lot, or arriving home to a garage). Other speeds may simply not be possible for the approach to these other locations. These speeds may be associated with a particular geofence and speed or velocity data which contradicts the range associated with a particular geofence may change the rate of requests.

In such examples, it may appear that the direction of approach from the highway versus the geofence may indicate a tangential, rather than a centric approach towards the geofence. The relationship of the vectors calculated (e.g., such as those described above with respect to FIG. 6) to the boundary of the geofence may be used to differentiate between a passing behavior and an approaching behavior. For example, with respect to geofence 620, a vector generated between positions 633 and 634 may indicate a tangential relationship to the geofence.

In various embodiments, the directionality of a vector along with the distance of a location to the boundary of a geofence may also be included in the set of training data.

Additional examples may include the use or collection of a connection period for a particular Wi-Fi source, before the mobile device is out of range or cannot observe or connect to that particular Wi-Fi source.

### C. Additional Differentiation and Classification Accuracy Using Wi-Fi fingerprinting

Additionally, Wi-Fi fingerprinting techniques can be used by machine learning or classifiers to further enable and improve approach. Wi-Fi fingerprinting techniques may be used to improve.

Wi-Fi scans (e.g., enhanced Preferred Network Offload (ePNO)) scans may be low-powered Wi-Fi scans that can be made at regular intervals. Wi-Fi scans may be used to scan for networks. During a particular route or approach to a geofence, a set of networks may be identified. These identified Wi-Fi networks can act as a fingerprint for a specific route taken towards a specific geofence. Additionally, each Wi-Fi location may be used to obtain a position estimate for the mobile device. Each Wi-Fi scan may thus provide a two-dimensional position estimate.

In various embodiments, such as when the directional motion classifier indicates a low probability of which geofence the mobile device may be approaching, information related to Wi-Fi networks can be used to improve classifications. In other examples, a Wi-Fi fingerprint can be used as input data. Other Wi-Fi related information, such as signal strength, relative direction between the mobile device and the Wi-Fi source, and GPS location can be used as training data for the directional motion classifier. In various embodiments, a specific geographical location may be known or associated with the Wi-Fi signal, which can be used to improve location estimates. In various embodiments, certain Wi-Fi signals may be known to be associated or related to a specific geofence, which may further improve accuracy of a classifier.

In various embodiments, an estimate from a directional motion classifier may indicate that it is expected that a certain Wi-Fi signal be present during a route taken from a current position to a geofence location that the classifier has classified as the most probable location being approached. The absence of such a Wi-Fi signal, or multiple Wi-Fi signals, on that approach may be used by the classifier to change the probability, as it may indicate that it is unlikely that the geofenced location is being approached. For example, the absence of an expected Wi-Fi signal may cause a penalty to be applied to an estimated probability. The penalty for one Wi-Fi signal may be a small penalty as a particular Wi-Fi source may be offline or inaccessible. On the other hand, the absence of multiple Wi-Fi sources may further penalize the estimated probability as it is unlikely that multiple Wi-Fi sources would not simultaneously be unavailable during a typical approach.

### D. Method for Fast Entry

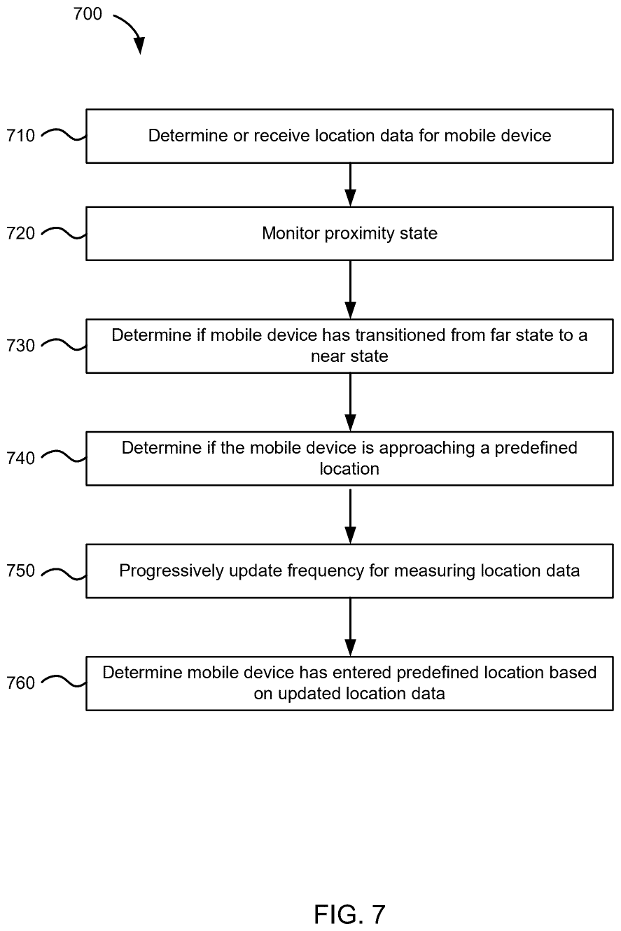

FIG. 7 is a flowchart of a method 700 related to various embodiments related to fast entry technology. Method 700 may first enable for a classification of a mobile device as being in a near state or far state to one or more geofenced areas. Upon determination that a mobile device is in a near state to a geofenced area, a directional motion classifier may be used to determine whether the mobile device is approaching a geofenced area. As the directional motion classifier determines that the mobile device is in an approaching state to a geofenced area, it may increase the rate of measuring location data for the mobile device. This may reduce the latency in determining that the mobile device has entered a geofenced area.

At block 710, location data may be determined or received over time for a mobile device. The location data may be using a wireless network circuitry and global navigation satellite system (GNSS) circuity. The location data may be collected periodically at a base frequency, such as for example, once a minute. This may ensure that the mobile device is not actively spending energy when it is not known that the mobile device is in a near state to a geofenced area.

At block 720, the proximity state of the mobile device relative to a predefined location may be monitored. The proximity state may be monitored based on the location data obtained. The proximity state may be a near state or a far state. In some examples, as described above, the proximity state may be a probability or other metric of how close or far the mobile device is to a geofenced area. For example, at block 720 the mobile device may be in a far state from geofenced area of interest.

At block 730, the proximity state of the mobile device as transitioning from a far state to a near state can be determined. The proximity state may transition from a far state to a near state based on the updated location data. In some examples, the proximity state may include a change in the distance values (or other metrics) with respect to a geofenced area. Upon determination that the proximity state is in a near state, other classifiers or techniques may be used responsive to the mobile device being in a near state.

At block 740, it may be determined whether the mobile device is approaching a predefined location. This determination may be based on a directional motion classifier. The directional motion classifier may use both absolute position data, calculated or estimated velocity, Wi-Fi fingerprinting, and other techniques described above. The directional motion classifier may also use other techniques to estimate the displacement, distance, or direction of motion of the mobile device. This may allow for an estimation of the direction of travel for the mobile device. The displacement model may provide estimations for the displacement that the mobile device has undergone. In some examples, prior to obtaining updated location data, the displacement model may provide information on the likely position of the device. The likely position may further increase or modify the nature of the.

At block 750, progressively increasing the update frequency for measuring the location data as the mobile device approaches the predefined location, thereby obtaining updated location data. The increase in frequency for measuring the location data may allow for better estimates of the location of the mobile device with respect to the entry of a geofenced area. Additionally, the directional motion classifier may continue to operate at this block, providing additional information about the likely position of the mobile device.

At block 760, determining the mobile device has entered the predefined location based on the updated location data. As the mobile device has an increased update frequency for the location data, determination that it has entered a predefined location may occur with lower latency.

### IV. Reducing False Exits from a Geofenced Area

Geolocation services rely on the accuracy of the location of a mobile device. For example, the automation of smart devices (e.g., lighting systems) are based on whether a mobile device is inside or outside a geofence (e.g., a geofence which defines the perimeter of a house). When a mobile device is near the boundary of a geofenced area, the lack of precision in the location data may cause this issue. Variation in the measurement may cause the mobile device to apparently leave and re-enter the geofence. For example, variation or small motion in the mobile device while a user is using his or her mobile device within his or her bedroom may cause a location data to change, and for the location of the device to erroneously appear as being outside the user's home.

Stated alternatively, a single outlying location reading may trigger an exit declaration from the geofenced area. This overreliance on position accuracy makes it appear that an exit from the geofenced area has occurred. False exits may pose a significant challenge to the usability of location-based services (e.g., smart devices which take action based on the perceived location of the smart device). Thus, solutions are required to reassess how position estimate errors are handled.

As further discussed below, various techniques can be used to reduce the number of false positives related to the exit of a mobile device from a geofenced area. This may include the use of pedestrian dead-reckoning techniques, inertial odometry, sensor fusion, modification to the size of a geofence, filtering of low-accuracy location data, time-delaying an average or estimate of locations, and the use of mobile device states.

Embodiments of the disclosed technology are provided to reduce the number of false exits from a geofenced area are further discussed below. As further discussed below, methods are provided to integrate data from multiple sources (e.g., GPS, Wi-Fi, and inertial odometry) to a location estimation module, which may then use the sources to generate a composite estimate. This estimate forms the basis for determining whether a user is within or outside a designated area.

Additionally, filtering mechanisms may be implemented to establish trust in location data before making determinations. For example, one approach involves analyzing the visible satellite count and signal strength of GPS providers. Additionally, the historical reliability of measurements, their variability, or precision, may be used to determine aspects of the location data. If location data cannot be improved based on this information, filtering or changing the interpretation of location data may be used to prevent false exits.

### A. Modifying Location Based on Uncertainty Estimations

Examples are provided below which relate to the interpretation of location position estimates and associated errors.

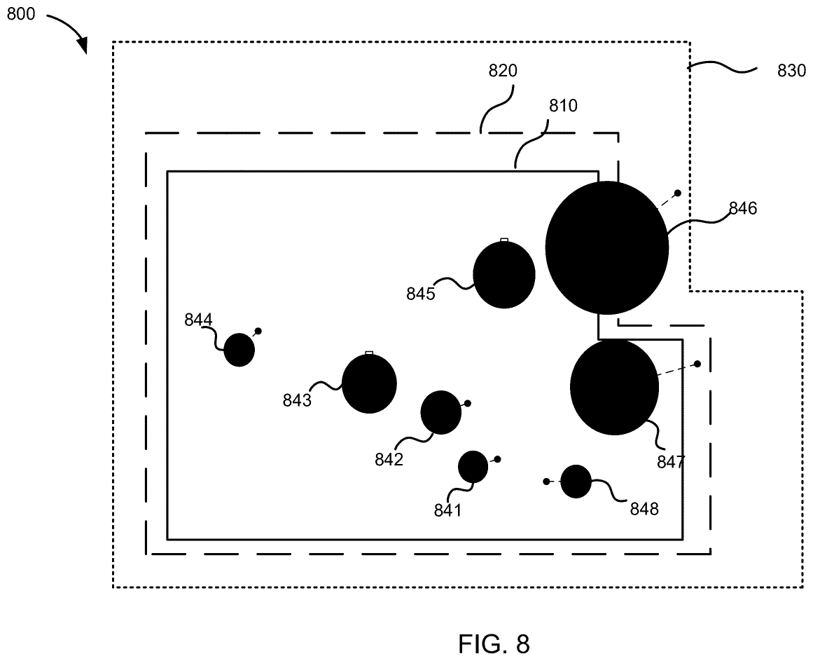

FIG. 8 is a two-dimensional representation 800. Illustrated on representation 800 is a building 810 with a geofence 820 defined around building 810. Geofence 820 may take an arbitrary shape around building 810. Although the geofences are illustrated to take the same shape as building 810, other shapes for the geofence, including circular shapes, are possible. Geofence 830 may be a geofence which is defined or based on geofence 820 and includes a boundary that is larger than the boundary of geofence 820. Also illustrated in representation 800 are a series of positions 841-848.

Building 810 may be a house, a workplace, or a or a designated location (e.g., a commonly visited store). The first geofence 820 may be a geofence which indicates that a mobile device has left building 810. However, due to error measurements, it may falsely appear that the mobile device has left building 810 prior to a true exit. In these situations, geofence 830, which may be a temporary and enlarged geofence based on uncertainty measurements, may be used to delay determination of an exit from building 810 until additional data is obtained which confirms that the mobile device has truly exited.

Illustrated in representation 800 are a series of positions 841-848. Each position is referred to as a singular position. Each position may be based on first location data and second location data. For example, the first location data may be represented by a “square” while the second location data may be represented by a small filled solid circle with a connecting dotted line. This may be illustrated as [symbol] in FIG. 8. The size of the position may relate to the uncertainty of the position based on the conflict between the first location data and the second location data. In some examples, the uncertainty may be small (e.g., positions 841, 844, and 848) while in other cases the uncertainty may be larger. The first location data may be GPS data while the second location data may be Wi-Fi, odometry, microlocation-based, or other positions derived based on data from one or more sensors of the mobile device.

Geofence 830 may be a temporary geofence, which is instantiated or created based on information provided by a location provider, including an “effective distance” metric. The “effective distance” metric may be based on various signals. The effective distance metric may account for contradictory signals by expanding the geofence boundary, which may allow for a reduction in the number of false exits. Factors such as an external power source, Wi-Fi association, motion of a mobile device, signal strength, and information from a classifier may be considered. Each of these inputs may contribute to the determination of the effective distance metric. The effective distance metric may be dynamic and adjust the geofence boundary by a certain size.

Turning back to positions 841-848, each position may have an uncertainty associated with it, which may be based on the first location data and the second location data. While there may be some uncertainty in determining both the first location data and the second location data, the best estimates or average value may be used for the first location data and the second location data. In some examples, the location data which is more reliable at that time may be used as the center of a specific position, while the other set of location data may be used for uncertainty estimates. Position 846 is an example of when one location data indicates that the mobile device has left geofence 820 but not geofence 830. Position 847 is an example where the mobile device is close to but has not left geofence. Position 848 which is later in time indicates that both sets of position data support that the device has not left geofence 820. In this manner, by expanding the geofence based on an “effective distance” metric or an uncertainty, a false exit may be prevented.

In some examples, an uncertainty can be calculated or estimated for each of positions 841-848. The uncertainty can be based on a weighted average between the first location data and the second location data. The weights may be based on the accuracy of the underlying location data. The uncertainty may be increased or decreased based on the underlying accuracy or reliability of the location data. The uncertainty may be represented by the size of the circle for each of positions 841-848. The “center” for each position 841-848 may be either a first location data or a second location data while the second location data or first location data forms a basis for the uncertainty for each position.

Positions 841-848 may be positions which are obtained using location estimates. These may include, for example, location estimates which are obtained using wireless network systems and global navigation satellite system (GNSS) systems, or GPS systems. Each position 841-848 may be obtained sequentially in time (e.g., each position estimate is obtained after one minute).

Positions 841-845 are illustrated as being located within geofence 820 and building 810. Position 846 is illustrated as being outside of geofence 820 and within geofence 830. Position 847 is illustrated as being near but within geofence 820. As further explained below, each of the positions 841-848 may include uncertainty and confidence information related to how the measurement was obtained. For example, at position 841, a GPS measurement may give a first position and a Wi-Fi signal may give a second position. An uncertainty shown at positions 841 may reflect an uncertainty between.

Additionally, positions 841-848 are illustrated with varying sizes. The size of positions 841-848 may indicate the uncertainty in the measurement of that position. For example, position 841 is of a smaller size than position 845. The uncertainty of other positions, such as position 848 may indicate that accuracy has increased over time, and that it was unlikely that the mobile device left geofence 820. As one example, positions 841-848 may represent a time series of mobile device movement.

Additionally, at each of positions 841-848, the first location data and the second location data may be consistent or inconsistent with one another. For example, the first location data and the second location data may be consistent with one another if they are less than a threshold distance from one another. The threshold distance may be based on historical averages of the accuracy of the first location data and the second location data. In other examples, the first location data and the second location data may be consistent if they are within a historical accuracy from one another (e.g., positions 841 and/or 848). The first location data and the second location data may be considered to be consistent if they are both within the same geofence. In some examples, the first location data and the second location data may be inconsistent with one another if they are farther apart than a threshold distance from one another and/or are farther apart than a metric based on historical information associated with the first location data and the second location data (e.g., accuracy, reliability, precision, centrality, etc.). In some examples, the first location data and the second location data may be considered to be inconsistent with one another when one is within a geofence and the other is outside a geofence.

Additionally, each measurement may have a state of a mobile device associated with it. For example, additional sensor or state information of the mobile device may be associated with each of positions 841-848. For example, gyroscope, accelerometer, device state (e.g., charging, face up or face down, mobile connectivity data) may all be associated with each of the positions 841-848.

For instance, at position 841, a user may be charging his or her mobile device. At this state, the location of the mobile device may be known with high accuracy due to the presence of a window or other line of sight to a satellite. The mobile device may have been stationary for a long period of time and without any motion (e.g., gyroscope or accelerometer information may be low). Additionally, at this position, the mobile device may have been charging. The state information of the mobile device may indicate a charging state as well as a “face down” state, indicating that little or no light information is entering the mobile device. Position 841 may also be an average of a series of positions which have been taken over a period of time which are less than a defined error from one another. This information may be clustered or reported as one position. Position 841 is of the smallest size in representation 800, indicating it is of the highest confidence.

At position 842, a user may have taken the mobile device and moved away from the charging position. For example, the user may have awoken and taken the mobile device with them. For instance, the user may be moving to another location within building 810, such as a kitchen. As the user moves, the accuracy of information derived from a satellite may be reduced. Thus, the size of position 842 is larger than that of position 841. Additionally, other information, such as information derived from the mobile device's gyroscope or accelerometer, may be obtained.

At position 843, the user may continue to move towards a kitchen. Position 843 may include an uncertainty estimate which is even larger than that of positions 841 and 842.

At position 844, the user may be stopped at a location within building 810 (e.g., a kitchen). At position 844, the uncertainty estimate of the position may be smaller than that of the earlier positions 841-843.

At position 845, the user may move to another location within building 810. At this position, the uncertainty associated with position 845 may be larger than the previous estimates. This may be due to a faster motion by the mobile device, a weaker signal strength, or variations in the building or connectivity which may cause the certainty in the position to be weaker. Position 845 may be close to a geofence 820.

Position 846 may appear to be outside of geofence 820. At this position, actions may be taken with respect to position 846, such as control or modification of smart home devices. However, position 846 may be a false positive or a “false exit” (e.g., mobile device is within geofence 820 but error or other factors cause the location of the mobile device to appear to be outside of geofence 820). Thus, delaying or modifying any actions to be taken based on the appearance of position 846 may improve the functioning of location-based services and reduce the number of false positives for the location.

In various embodiments, the size of geofence 820 may be increased to geofence 830. This may occur when the location of the mobile device is being indicated as position 846 (which is the first position outside of geofence 820 in the series of positions illustrated). At this time, declaring an exit based on position 846 may be delayed. The amount of delay in declaring the exit may be based on the magnitude of the uncertainty measurement, other device sensor data, historical uncertainty measurements, time series data, etc.

Position 847, which is a location estimate which is later in time, may have a smaller uncertainty than position 846. Additionally, position 847 may be on the border of geofence 820. However, as position 847 is within geofence 830, the delay in declaring an exit from geofence 820 at position 846 would have prevented a false positive for an exit from the geofence. However, in various embodiments, if position 847 (and positions onwards) were outside of geofence 830, the exit may be considered to have been a true exit.

Position 848 may have a smaller uncertainty measurement than position 847. When the mobile device is at position 848, geofence 830 may be made smaller or eliminated. Additionally, if a device state changes at position 848 (e.g., the mobile device being in a charging state), then geofence 830 may be eliminated.

At each time corresponding with positions 841-848, a hypothesis can be created of the location of the mobile device. For each position, multiple hypotheses can be created based on multiple sources of location information (e.g., wireless data, GNSS data) or device state information.

### B. Classifiers, Training Using a Replay System, Additional Techniques, and Use of Device States (e.g., Charging, stationary)

The following techniques and methods may be used with respect to the discussion above to better estimate the true state of a mobile device and determination of an effective distance metric.

In various embodiments, a location estimation module may use one or more algorithms to determine the location of the mobile device. A location estimation module may use any of the following techniques.

Inertial odometry is a method used to estimate the position and orientation of a mobile device by integrating measurements from inertial sensors such as accelerometers and gyroscopes. Accelerometers may measure linear acceleration along different axes, while gyroscopes may measure the rate of rotation around these axes. By integrating the data from these sensors over time, inertial odometry algorithms may estimate changes in position and orientation. Yet, these sensors may be subject to errors such as drift and noise. Thus, the accuracy of inertial odometry may degrade over time, and other techniques can be used to improve or validate estimates derived using inertial odometry.

To improve accuracy, inertial odometry may be combined with other localization techniques such as GNSS, GPS, visual odometry, the use of microlocations, or SLAM. The fusion of data from multiple sensors may help to correct errors and maintain accurate estimates of position and orientation over longer periods.

Sensor fusion may use various techniques to combine and constrain raw sensor data in ways to create a reasonable record of motion. Sensor fusion techniques may assist with determining or estimating the location of the mobile device. Sensor fusion may also use the uncertainty data and have a pre-filtering stage to filter out information that is considered too uncertain.

Additionally, the location estimation system may make determinations based on the types of information available and underlying uncertainty. For example, the location estimation system may consider the signal strength of the GPS provider in making location estimations.

Additionally, a location estimation system may use a classifier. In various embodiments, the classifier may be trained through replay techniques. The classifier may provide an output of whether or not the mobile device is inside or outside a geofenced area, as well as a probability associated with the classification.

For example, the replay techniques may be used to replay sets of data to ensure that previous provided data is properly weighted. For instance, replay in the context of machine learning (e.g., in training neural networks) can ensure that previous data used to train a model is not “forgotten” by the model. Machine learning training techniques may require a reweighting of all weights in a machine learning model when new data is provided. In one implementation, replay involves storing a subset of previous veridical inputs and mixing those inputs with more recent inputs. This preserves representations for processing previous inputs while enabling new information to be learned. These techniques may ensure stability when a defined geofence is changed, additional data is obtained or new data is obtained from motion of the mobile device through normal use. In various embodiments, user input can be obtained when a false exit occurs, and this input (that may be considered true), can be used to retrain the classifier to obtain an updated version of the same.

State information related to the device may also be used to evaluate the type of errors and the possible modifications to the techniques or processing used by the location estimation module. For example, historical information may indicate that a certain percentage of false exits occur when the device is in a stationary state or a charging state. Due to the conflict of signals (e.g., a GPS signal indicating the mobile device has left the geofence and a second signal indicating that the mobile device is stationary), the use of state information may be a precursor to analysis by the location estimation module. In such an example, a timed delay or increase in the uncertainty of the location estimate provided by the location estimation module may be used to reduce the number of false exits.

Once a determination has been made that a mobile device has left a geofence, a periodic measurement of a location of the mobile device may be made as a background process of the geofence rather than when an application on the mobile device requests a location. If there are locations which occur outside of a first geofence, measurement rates may be increased in order to determine more quickly whether or not an exit has actually occurred.

### C. Method for Reducing False Exits

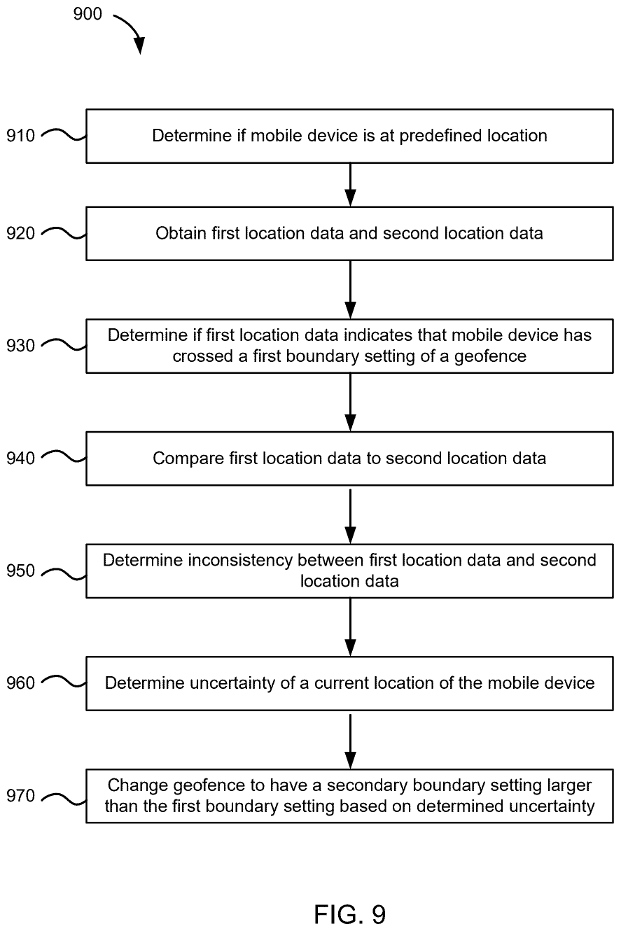

FIG. 9 is a flowchart of a method 900 related to various embodiments related to reducing false exits.

At block 910, it may be determined that the mobile device is at a predefined location with a geofence defined for the mobile device. For example, the predefined location may be a geofence defined around a building, such as geofence 820 that is around building 810.

At block 920, first location data and second location data may be obtained or measured. For example, first location data may be received using a global navigation satellite system (GNSS) circuitry of a mobile device. Second location may be measured using wireless network circuitry or motion sensors.

At block 930, it may be determined that the first location data indicates that the mobile device has crossed a first boundary setting of the geofence. For example, GNSS data may indicate that the mobile device has crossed geofence 820. This may correspond to, for example, position 846 described with respect to FIG. 8.

At block 940, the first location data may be compared to the second location data. The comparison step may occur at a location estimation module. The comparison may involve checking the consistency between the first location data and the second location data

At block 950, it may be determined that the first location data indicating the mobile device has crossed the first boundary setting of the geofence is not consistent with the second location data. For example, first location data may indicate that the geofence has been crossed, but second location data (e.g., motion data) may indicate that the mobile device has been stationary and that the geofence could not have been crossed.

At block 960, an uncertainty of a current location of the mobile device using the first location data and the second location data may be determined. The uncertainty may be based on predictive techniques, accuracy information for the first signal or the second signal, or probability measurements.

At block 970, the geofence may be changed by having a second boundary setting that is larger than the first boundary setting based on the uncertainty. This may cause the current location of the mobile device to remain at the predefined location.

### V. Auxiliary Processor Managing Sensor Measurements

As described herein, the ability to collect location data (or information) and generate accurate locations can provide benefits and services to the users. However, a large amount of historical location data may need to be stored while the mobile device is in a low-power state (e.g., sleep mode).

An auxiliary processor architecture can utilize a certain part of storage space (e.g., cache memory of a main processor and referred to herein as cache) of a mobile device that is not being used while the main processor (e.g., application processor (AP)) is in a low-power mode (e.g., a sleep mode) to store historical location data. After the AP wakes up (i.e., exits the sleep mode), the stored historical location data can be moved from the cache memory (e.g., static random-access memory (SRAM)) to larger system memory (e.g., dynamic random-access memory (DRAM)), where the AP can access and process the stored historical location data while performing its normal function to use its cache memory. The auxiliary processor (e.g., an always-on processor) is powered on more often than the application processor.

### A. System Components

The always-on system architecture may include one or more processors and various components (e.g., sensors, storage, interfaces, etc.) to provide the always-on functionality and experience to a user of a mobile device. The architecture may be implemented on a system-on-chip (SoC) or a circuit board to tightly integrate the components.

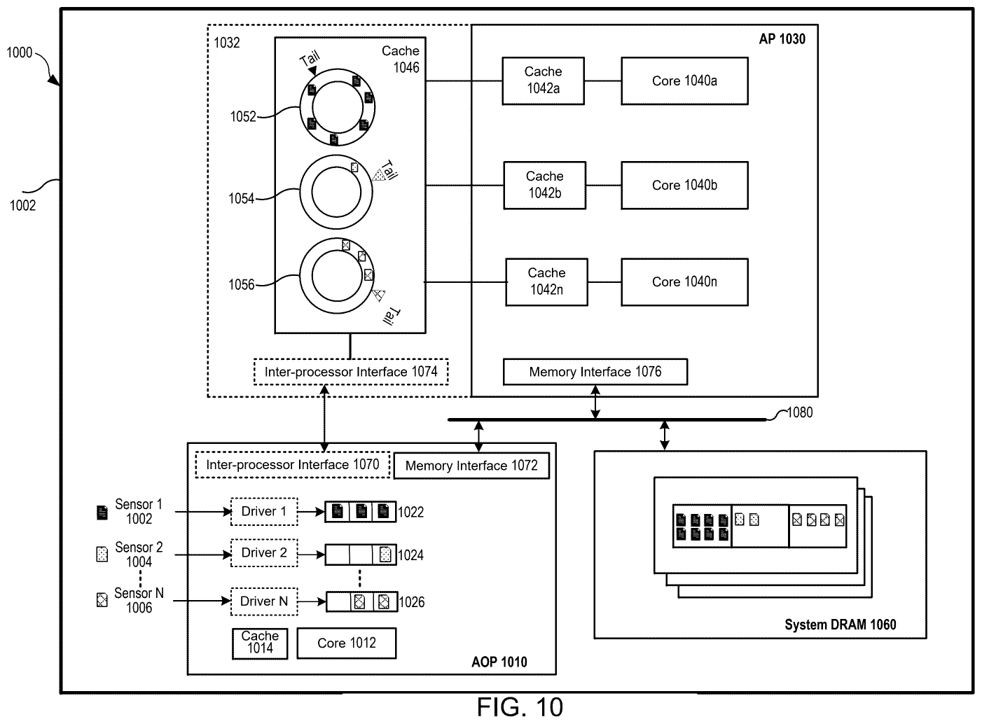

FIG. 10 is a block diagram of an example always-on system architecture 1000, which may include a system-on-chip (SoC) 1002 in a mobile device. In some embodiments, 1002 may be a circuit board. The architecture 1000 may be a multiprocessor system. SoC 1002 may include an always-on processor (AOP) 1010, an application processor (AP) 1030, system memory (e.g., DRAM) 1060, and cache memory 1046 (referred to as cache) in a module 1032 that may or may not be part of AP 1030.

It should be apparent that the architecture 1000 shown in FIG. 10 is only one example, and that SoC 1002 can have more or fewer components than shown, or a different configuration of components. The various components shown in FIG. 10 can be implemented in hardware, software, or a combination of both hardware and software, including one or more signal processing and/or application specific integrated circuits. In some embodiments, AOP 1010 and AP 1030 may be different integrated circuits (ICs referred to as chips) on a circuit board.

In FIG. 10, AOP 1010 may be a small, low-power auxiliary processor that is always active for interacting with sensors, handling background operations, and waking up the operating system running on AP 1030. Sensor measurements related to locations are referred to herein as location data. AOP 1010 may have one or more processor cores 1012 and local cache 1014. One or more small buffers (e.g., 1022, 1024, and 1026) can be used to temporarily store location data from various sensors (e.g., sensor 1 1002, sensor 2 1004, and sensor N 1006), one buffer per sensor (e.g., buffer 1022 for sensor 1 1002, buffer 1024 for sensor 2 1004, and buffer 1026 for sensor N 1006). In some embodiments, a shared buffer space may be used to store data for all sensors. AOP may also include, but is not limited to, an inter-processor interface 1070 for communicating with another processor (e.g., AP 1030) and a memory interface 1072 for accessing system DRAM 1060.

The sensors 1002-1006 may be different location technologies, such as wireless fidelity (Wi-Fi), Bluetooth (BT), Bluetooth Low Energy or BLE, Global Positioning System (GPS), ultrawideband (UWB), etc. The raw location data from the sensors may be processed by their respective drivers before being placed into a buffer for each sensor.

AP 1030 may be the main processor on a mobile device (e.g., phone or wearable watch) for processing data and performing user-facing tasks. The AP 1030 may be a single or multicore processor (e.g., cores 1040a-1040n). Each core may have a small local cache (e.g., layer-1 (L1) cache) tightly integrated with the core. The AP 1030 may also have one or more larger caches 1046, such as layer-2 (L2) or layer-3 (L3) cache, that may or may not be integrated with the AP (i.e., on the same chip). The AP 1030 may also include, but is not limited to, an inter-processor interface 1040 for communicating with another processor (e.g., AOP 1010) and a memory interface 1072 for accessing system DRAM 1060.

The cache 1046 that can be accessed by both AOP 1010 and AP 1030 may be on the SoC 1002. In some embodiments, the cache 1046 (e.g., L2 or L3 cache for AP) may be integrated with and become part of AP 1030. In that case, AOP 1010 may communicate with and access the cache 1046 through the inter-processor interface 1070 of AOP 1010 and the inter-processor interface 1074 of AP 1030. The inter-processor interfaces (1070 and 1074) may include various cache coherency mechanisms for maintaining cache coherence between AP 1030 and AOP 1010, as well as secured communication mechanisms. In other embodiments, the cache 1046 may be separated from (or not integrated with) AP 1030. As a result, AOP 1010 may communicate with and access the cache 1046 directly without using the inter-processor interfaces (1070 and 1074). In such case, cache coherency and secured communication mechanisms may be supported by other components (not shown) on the SoC 1002.

A bus subsystem 1080 may provide a mechanism for various components and subsystems to communicate with each other. For example, AOP 1010 and AP 1030 may access system memory 1060 using their respective memory interfaces 1072 and 1076.

System memory 1060 may provide temporary data storage for AP 1030 to access and execute programs or applications. System memory 1060 typically includes Dynamic Random-Access Memory (DRAM) in large quantity to store a large amount of data, and is shared among processors (e.g., AOP 1010 and AP 1030).

### B. System Operations and Data Flow

As discussed above, the always-on system architecture 1000 may provide an all-day buffering capability to temporarily store location data from various sensors when the AP 1030 is not active, such as in sleep mode. Once AP 1030 wakes up and becomes active, the buffered location data can be processed. Since different parts of the storage space on the SoC 1002 may be available when the AP 1030 is asleep or awake, the temporarily stored location data may be moved depending on AP's status to make the best use of under-utilized resources and conserve power consumption.

For example, typically, processor cache memory may be implemented with static random-access memory (SRAM) in small quantities with faster access speed. The processor cache is available to use even when AP is asleep. On the other hand, system memory may be implemented in dynamic random-access memory (DRAM) in large quantities with slower access speed. DRAM may need to be constantly refreshed, and not available to use when AP is asleep to save power.

Because the cache 1046 and the system DRAM 1060 are available at different times, the AOP 1010 may be configured to transfer or move the stored historical location data at the appropriate time.

As mentioned above, historical location data from sensors (1002-1006) may be temporarily stored in their corresponding buffers (1022-1026) in AOP 1010. The data in each buffer may then be securely transferred to the cache 1046 (through inter-processor interfaces 1070 and 1074 or not) when more data arrives. The storage space in the cache 1046 may be organized into multiple circular buffers or queues (1052-1056), one for location data from each sensor, for example, circular buffer 1052 for sensor 1 1002, circular buffer 1054 for sensor 2 1004, and circular buffer 1056 for sensor N 1006. A circular buffer may hold a duration of location data (e.g., 15 minutes to an hour or more). Once the capacity of the circular buffer is reached, new data may overwrite the old data. Thus, each circular buffer may have an indicator (“tail”) indicating the start/end of its stored content. In some embodiments, the storage space in the cache 1046 may not be partitioned but used for storing location data from all sensors by using an identifier for each sensor, for example, ID 1 for sensor 1's data 1002, ID2 for sensor 2's data 1024, etc.

When AP 1030 wakes up, AOP 1010 may move the stored historical location data in cache 1046 to system DRAM 1060 via memory interface 1072 and bus subsystem 1080 using a security protocol. The security protocol may ensure the data being transferred is tempered proof. The AP 1030 can then access the historical location data from the system DRAM 1060 via its memory interface 1076 and bus subsystem 1080. In some embodiments, the AP 1030 can start accessing and processing the historical location data in the system DRAM 1060 once the data is available and before the AOP 1010 completes the data transfer. In other words, the cache 1046 of the always-on system architecture 1000 may act as a store-and-forward buffer.

### VI. Example AI/ML Implementation

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provider transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

A “machine learning model” (ML model) can refer to a software module configured to be run on one or more processors to provide a classification or numerical value of a property of one or more samples. An ML model can include various parameters (e.g., for coefficients, weights, thresholds, functional properties of function, such as activation functions). As examples, an ML model can include at least 10, 100, 1,000, 5,000, 10,000, 50,000, 100,000, or one million parameters. An ML model can be generated using sample data (e.g., training samples) to make predictions on test data. Various number of training samples can be used, e.g., at least 10, 100, 1,000, 5,000, 10,000, 50,000, 100,000, or at least 200,000 training samples. One example is an unsupervised learning model such as hidden Markov model (HMM), clustering (e.g., hierarchical clustering, k-means, mixture models, model-based clustering, density-based spatial clustering of applications with noise (DBSCAN), and OPTICS algorithm), approaches for learning latent variable models such as Expectation-maximization algorithm (EM), method of moments, and blind signal separation techniques (e.g., principal component analysis, independent component analysis, non-negative matrix factorization, singular value decomposition), and anomaly detection (e.g., local outlier factor and isolation forest). Another example type of model is supervised learning that can be used with embodiments of the present disclosure. Example supervised learning models may include different approaches and algorithms including analytical learning, statistical models, artificial neural network (e.g. including convolutional and/or transformer layers) that may have 1-10 layers as examples, recurrent neural network (e.g., long short term memory, LSTM), boosting (meta-algorithm), bootstrap aggregating (bagging) such as random forests, support vector machine (SVM), support vector (SVR), Bayesian statistics, case-based reasoning, decision tree learning, inductive logic programming, linear regression, logistic regression, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, nearest neighbor algorithm, probably approximately correct learning (PAC) learning, ripple down rules, a knowledge acquisition methodology, symbolic machine learning algorithms, subsymbolic machine learning algorithms, minimum complexity machines (MCM), ordinal classification, data pre-processing, handling imbalanced datasets, statistical relational learning, or Proaftn (a multicriteria classification algorithm), or an ensemble of any of these types. Supervised learning models can be trained in various ways using various cost/loss functions that define the error from the known label (e.g., least squares and absolute difference from known classification) and various optimization techniques, e.g., using backpropagation, steepest descent, conjugate gradient, and Newton and quasi-Newton techniques.

### VII. Example Device

FIG. 11 is a block diagram of an example electronic device 1100 according to at least one embodiment. Device 1100 generally includes computer-readable medium 1102, a processing system 1104, an Input/Output (I/O) subsystem 1106, wireless circuitry 1108, and audio circuitry 1110 including speaker 1112 and microphone 1114. These components may be coupled by one or more communication buses or signal lines 1103. Device 1100 can be any portable electronic device, including a handheld computer, a tablet computer, a mobile phone, laptop computer, tablet device, media player, personal digital assistant (PDA), a key fob, a car key, an access card, a multifunction device, a mobile phone, a portable gaming device, a headset, or the like, including a combination of two or more of these items.

It should be apparent that the architecture shown in FIG. 11 is only one example of an architecture for device 1100, and that device 1100 can have more or fewer components than shown, or a different configuration of components. The various components shown in FIG. 11 can be implemented in hardware, software, or a combination of both hardware and software, including one or more signal processing and/or application specific integrated circuits.

Wireless circuitry 1108 is used to send and receive information over a wireless link or network to one or more other devices' conventional circuitry such as an antenna system, a radio frequency (RF) transceiver, one or more amplifiers, a tuner, one or more oscillators, a digital signal processor, a coder-decoder (CODEC) chipset, memory, etc. Wireless circuitry 1108 can use various protocols, e.g., as described herein. In various embodiments, wireless circuitry 1108 is capable of establishing and maintaining communications with other devices using one or more communication protocols, including time division multiple access (TDMA), code division multiple access (CDMA), global system for mobile communications (GSM), Enhanced Data GSM Environment (EDGE), wideband code division multiple access (W-CDMA), Long Term Evolution (LTE), LTE-Advanced, Wi-Fi (such as Institute of Electrical and Electronics Engineers (IEEE) 802.11a, IEEE 802.11b, IEEE 802.11g and/or IEEE 802.11n), Bluetooth, Wi-MAX, Voice Over Internet Protocol (VOIP), near field communication protocol (NFC), a protocol for email, instant messaging, and/or a short message service (SMS), or any other suitable communication protocol, including communication protocols not yet developed as of the filing date of this document.

Wireless circuitry 1108 is coupled to processing system 1104 via peripherals interface 1116. Peripherals interface 1116 can include conventional components for establishing and maintaining communication between peripherals and processing system 1104. Voice and data information received by wireless circuitry 1108 (e.g., in speech recognition or voice command applications) is sent to one or more processors 1118 via peripherals interface 1116. One or more processors 1118 are configurable to process various data formats for one or more application programs 1134 stored on medium 1102.

Peripherals interface 1116 couple the input and output peripherals of device 1100 to the one or more processors 1118 and computer-readable medium 1102. One or more processors 1118 communicate with computer-readable medium 1102 via a controller 1120. Computer-readable medium 1102 can be any device or medium that can store code and/or data for use by one or more processors 1118. Computer-readable medium 1102 can include a memory hierarchy, including cache, main memory and secondary memory. The memory hierarchy can be implemented using any combination of random access memory (RAM) (e.g., static random access memory (SRAM,) dynamic random access memory (DRAM), double data random access memory (DDRAM)), read only memory (ROM), FLASH, magnetic and/or optical storage devices, such as disk drives, magnetic tape, CDs (compact disks) and DVDs (digital video discs). In some embodiments, peripherals interface 1116, one or more processors 1118, and controller 1120 can be implemented on a single chip, such as processing system 1104. In some other embodiments, they can be implemented on separate chips.

Processor(s) 1118 can include hardware and/or software elements that perform one or more processing functions, such as mathematical operations, logical operations, data manipulation operations, data transfer operations, controlling the reception of user input, controlling output of information to users, or the like. Processor(s) 1118 can be embodied as one or more hardware processors, microprocessors, microcontrollers, field programmable gate arrays (FPGAs), application-specified integrated circuits (ASICs), or the like.

Device 1100 also includes a power system 1142 for powering the various hardware components. Power system 1142 can include a power management system, one or more power sources (e.g., battery, alternating current (AC)), a recharging system, a power failure detection circuit, a power converter or inverter, a power status indicator (e.g., a light emitting diode (LED)) and any other components typically associated with the generation, management and distribution of power in mobile devices.

In some embodiments, device 1100 includes a camera 1144. In some embodiments, device 1100 includes sensors 1146. Sensors can include accelerometers, compass, gyrometer, pressure sensors, audio sensors, light sensors, barometers, and the like. Sensors 1146 can be used to sense location aspects, such as auditory or light signatures of a location.

In some embodiments, device 1100 can include a GPS receiver, sometimes referred to as a GPS unit 1148. A mobile device can use a satellite navigation system, such as the Global Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information.

One or more processors 1118 run various software components stored in medium 1102 to perform various functions for device 1100. In some embodiments, the software components include an operating system 1122, a communication module 1124 (or set of instructions), a location module 1126 (or set of instructions), an offline maps module 1128 that is used as part of downloading offline maps as described herein, and other application programs 1134 (or set of instructions).

Operating system 1122 can be any suitable operating system, including iOS, Mac OS, Darwin, Real Time Operating System (RTXC), LINUX, UNIX, OS X, WINDOWS, or an embedded operating system such as VxWorks. The operating system can include various procedures, sets of instructions, software components and/or drivers for controlling and managing general system tasks (e.g., memory management, storage device control, power management, etc.) and facilitates communication between various hardware and software components.

Communication module 1124 facilitates communication with other devices over one or more external ports 1136 or via wireless circuitry 1108 and includes various software components for handling data received from wireless circuitry 1108 and/or external port 1136. External port 1136 (e.g., universal serial bus (USB), FireWire, Lightning connector, 60-pin connector, etc.) is adapted for coupling directly to other devices or indirectly over a network (e.g., the Internet, wireless local area network (LAN), etc.).

Location/motion module 1126 can assist in determining the current position (e.g., coordinates or other geographic location identifiers) and motion of device 1100. Modern positioning systems include satellite-based positioning systems, such as Global Positioning System (GPS), cellular network positioning based on “cell IDs,” and Wi-Fi positioning technology based on a Wi-Fi networks. GPS also relies on the visibility of multiple satellites to determine a position estimate, which may not be visible (or have weak signals) indoors or in “urban canyons.” In some embodiments, location/motion module 1126 receives data from GPS unit 1148 and analyzes the signals to determine the current position of the mobile device. In some embodiments, location/motion module 1126 can determine a current location using Wi-Fi or cellular location technology. For example, the location of the mobile device can be estimated using knowledge of nearby cell sites and/or Wi-Fi access points with knowledge also of their locations. Information identifying the Wi-Fi or cellular transmitter is received at wireless circuitry 1108 and is passed to location/motion module 1126. In some embodiments, the location module receives the one or more transmitter IDs. In some embodiments, a sequence of transmitter IDs can be compared with a reference database (e.g., Cell ID database, Wi-Fi reference database) that maps or correlates the transmitter IDs to position coordinates of corresponding transmitters, and computes estimated position coordinates for device 1100 based on the position coordinates of the corresponding transmitters. Regardless of the specific location technology used, location/motion module 1126 receives information from which a location fix can be derived, interprets that information, and returns location information, such as geographic coordinates, latitude/longitude, or other location fix data.

The offline maps module 1128 may send and/or receive map and/or service data messages to/from an antenna, e.g., connected to wireless circuitry 1108. The map and or service data may be used by one or more services, including a routing service, a vector tiles service, a search service, and other such services. The offline maps module 1128 can exist on various processors of the device, e.g., an always-on processor (AOP), a UWB chip, and/or an application processor.

The one or more applications 1134 on device 1100 can include any applications installed on the device 1100, including without limitation, a browser, address book, contact list, email, instant messaging, social networking, word processing, keyboard emulation, widgets, JAVA-enabled applications, encryption, digital rights management, voice recognition, voice replication, a music player (which plays back recorded music stored in one or more files, such as MP3 or AAC files), etc.

There may be other modules or sets of instructions (not shown), such as a graphics module, a time module, etc. For example, the graphics module can include various conventional software components for rendering, animating and displaying graphical objects (including without limitation text, web pages, icons, digital images, animations and the like) on a display surface. In another example, a timer module can be a software timer. The timer module can also be implemented in hardware. The time module can maintain various timers for any number of events.

I/O subsystem 1106 can be coupled to a display system (not shown), which can be a touch-sensitive display. The display displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments.

In some embodiments, I/O subsystem 1106 can include a display and user input devices such as a keyboard, mouse, and/or trackpad. In some embodiments, I/O subsystem 1106 can include a touch-sensitive display. A touch-sensitive display can also accept input from the user based at least part on haptic and/or tactile contact. In some embodiments, a touch-sensitive display forms a touch-sensitive surface that accepts user input. The touch-sensitive display/surface (along with any associated modules and/or sets of instructions in computer-readable medium 1102) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, I/O subsystem 1106 can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, device 1100 can include a touchpad (not shown) for activating or deactivating particular functions. In some embodiments, the touchpad is a touch-sensitive area of the device that, unlike the touch screen, does not display visual output. The touchpad can be a touch-sensitive surface that is separate from the touch-sensitive display, or an extension of the touch-sensitive surface formed by the touch-sensitive display.

### VIII. Example API Implementation

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

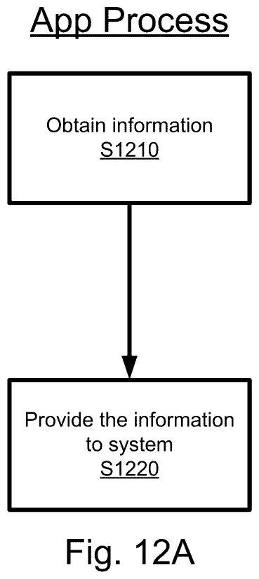

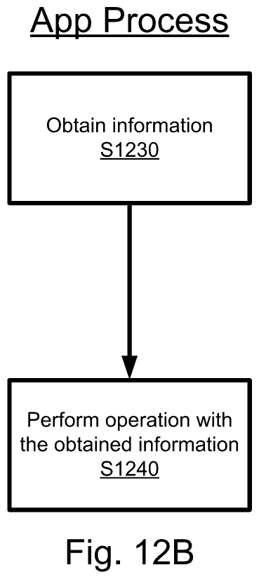

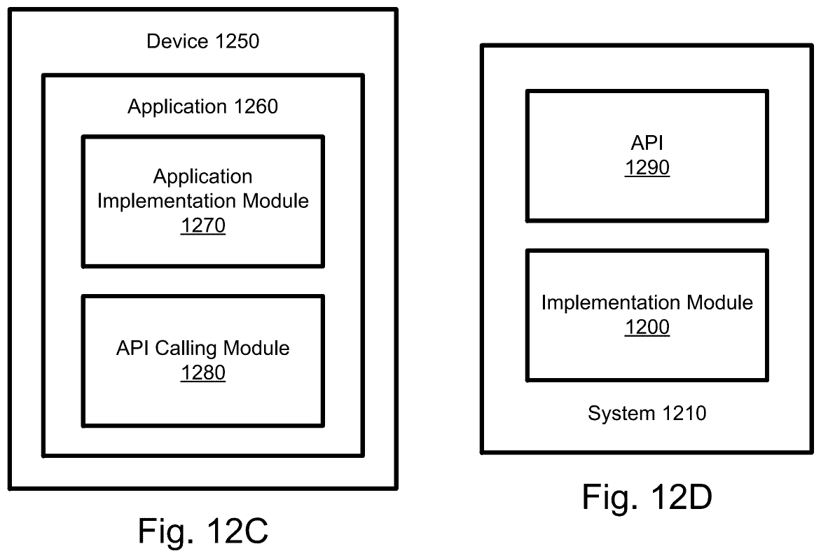

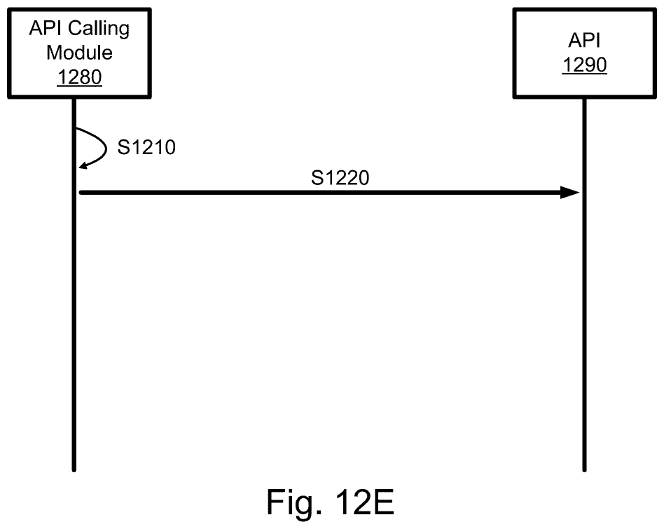

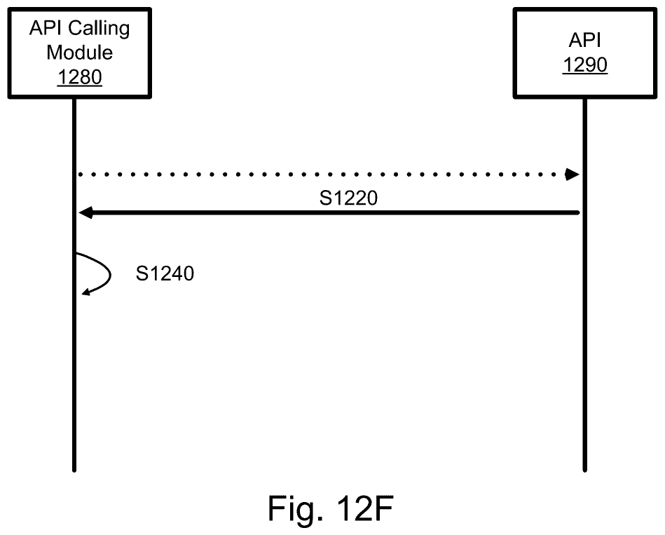

Implementations within the scope of the present disclosure include a computer-readable storage medium that encodes instructions organized as an application (e.g., application 1260) that, when executed by one or more processing units, control an electronic device (e.g., device 1250) to perform the method of FIG. 12A, the method of FIG. 12B, and/or one or more other processes and/or methods described herein.

It should be recognized that application 1260 (shown in FIG. 12C) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 1260 is an application that is pre-installed on device 1250 at purchase (e.g., a first party application). In other embodiments, application 1260 is an application that is provided to device 1250 via an operating system update file (e.g., a first party application or a second party application). In other embodiments, application 1260 is an application that is provided via an application store. In some embodiments, the application store can be an application store that is pre-installed on device 1250 at purchase (e.g., a first party application store). In other embodiments, the application store is a third-party application store (e.g., an application store that is provided by another application store, downloaded via a network, and/or read from a storage device).

Referring to FIG. 12A and FIG. 12E, application 1260 obtains information (e.g., S1210). In some embodiments, at S1210, information is obtained from at least one hardware component of the device 1250. In some embodiments, at S1210, information is obtained from at least one software module of the device 1250. In some embodiments, at S1210, information is obtained from at least one hardware component external to the device 1250 (e.g., a peripheral device, an accessory device, a server, etc.). In some embodiments, the information obtained at S1210 includes positional information, time information, notification information, user information, environment information, electronic device state information, weather information, media information, historical information, event information, hardware information, and/or motion information. In some embodiments, in response to and/or after obtaining the information at S1210, application 1260 provides the information to a system (e.g., S1220).

In some embodiments, the system (e.g., 1210 shown in FIG. 12D) is an operating system hosted on the device 1250. In some embodiments, the system (e.g., 1210 shown in FIG. 12D) is an external device (e.g., a server, a peripheral device, an accessory, a personal computing device, etc.) that includes an operating system.

Referring to FIG. 12B and FIG. 12F, application 1260 obtains information (e.g., S1230). In some embodiments, the information obtained at S1230 includes positional information, time information, notification information, user information, environment information electronic device state information, weather information, media information, historical information, event information, hardware information and/or motion information. In response to and/or after obtaining the information at S1230, application 1260 performs an operation with the information (e.g., S1240). In some embodiments, the operation performed at S1240 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 1210 based on the information.

In some embodiments, one or more steps of the method of FIG. 12A and/or the method of FIG. 12B is performed in response to a trigger. In some embodiments, the trigger includes detection of an event, a notification received from system 1210, a user input, and/or a response to a call to an API provided by system 1210.

In some embodiments, the instructions of application 1260, when executed, control device 1250 to perform the method of FIG. 12A and/or the method of FIG. 12B by calling an application programming interface (API) (e.g., API 1290) provided by system 1210. In some embodiments, application 1260 performs at least a portion of the method of FIG. 12A and/or the method of FIG. 12B without calling API 1290.

In some embodiments, one or more steps of the method of FIG. 12A and/or the method of FIG. 12B includes calling an API (e.g., API 1290) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 12C, device 1250 is illustrated. In some embodiments, device 1250 is a personal computing device, a smart phone, a smart watch, a fitness tracker, a head mounted display (HMD) device, a media device, a communal device, a speaker, a television, and/or a tablet. As illustrated in FIG. 12C, device 1250 includes application 1260 and operating system (e.g., system 1210 shown in FIG. 12D). Application 1260 includes application implementation module 1270 and API calling module 1280. System 1210 includes API 1290 and implementation module 1200. It should be recognized that device 1250, application 1260, and/or system 1210 can include more, fewer, and/or different components than illustrated in FIG. 12C and 12D.

In some embodiments, application implementation module 1270 includes a set of one or more instructions corresponding to one or more operations performed by application 1260. For example, when application 1260 is a messaging application, application implementation module 1270 can include operations to receive and send messages. In some embodiments, application implementation module 1270 communicates with API calling module to communicate with system 1210 via API 1290 (shown in FIG. 12D).

In some embodiments, API 1290 is a software module (e.g., a collection of computer-readable instructions) that provides an interface that allows a different module (e.g., API calling module 1280) to access and/or use one or more functions, methods, procedures, data structures, classes, and/or other services provided by implementation module 1200 of system 1210. For example, API-calling module 1280 can access a feature of implementation module 1200 through one or more API calls or invocations (e.g., embodied by a function or a method call) exposed by API 1290 and can pass data and/or control information using one or more parameters via the API calls or invocations. In some embodiments, API 1290 allows application 1260 to use a service provided by a Software Development Kit (SDK) library. In other embodiments, application 1260 incorporates a call to a function or method provided by the SDK library and provided by API 1290 or uses data types or objects defined in the SDK library and provided by API 1290. In some embodiments, API-calling module 1280 makes an API call via API 1290 to access and use a feature of implementation module 1200 that is specified by API 1290. In such embodiments, implementation module 1200 can return a value via API 1290 to API-calling module 1280 in response to the API call. The value can report to application 1260 the capabilities or state of a hardware component of device 1250, including those related to aspects such as input capabilities and state, output capabilities and state, processing capability, power state, storage capacity and state, and/or communications capability. In some embodiments, API 1290 is implemented in part by firmware, microcode, or other low level logic that executes in part on the hardware component.

In some embodiments, API 1290 allows a developer of API-calling module 1280 (which can be a third-party developer) to leverage a feature provided by implementation module 1200. In such embodiments, there can be one or more API-calling modules (e.g., including API-calling module 1280) that communicate with implementation module 1200. In some embodiments, API 1290 allows multiple API-calling modules written in different programming languages to communicate with implementation module 1200 (e.g., API 1290 can include features for translating calls and returns between implementation module 1200 and API-calling module 1280) while API 1290 is implemented in terms of a specific programming language. In some embodiments, API-calling module 1280 calls APIs from different providers such as a set of APIs from an OS provider, another set of APIs from a plug-in provider, and/or another set of APIs from another provider (e.g., the provider of a software library) or creator of the another set of APIs.

Examples of API 1290 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API. In some embodiments the sensor API is an API for accessing data associated with a sensor of device 1250. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 1200 is an system (e.g., operating system, server system) software module (e.g., a collection of computer-readable instructions) that is constructed to perform an operation in response to receiving an API call via API 1290. In some embodiments, implementation module 1200 is constructed to provide an API response (via API 1290) as a result of processing an API call. By way of example, implementation module 1200 and API-calling module 180 can each be any one of an operating system, a library, a device driver, an API, an application program, or other module. It should be understood that implementation module 1200 and API-calling module 1280 can be the same or different type of module from each other. In some embodiments, implementation module 1200 is embodied at least in part in firmware, microcode, or other hardware logic.

In some embodiments, implementation module 1200 returns a value through API 1290 in response to an API call from API-calling module 1280. While API 1290 defines the syntax and result of an API call (e.g., how to invoke the API call and what the API call does), API 1290 might not reveal how implementation module 1200 accomplishes the function specified by the API call. Various API calls are transferred via the one or more application programming interfaces between API-calling module 1280 and implementation module 1200. Transferring the API calls can include issuing, initiating, invoking, calling, receiving, returning, and/or responding to the function calls or messages. In other words, transferring can describe actions by either of API-calling module 1280 or implementation module 1200. In some embodiments, a function call or other invocation of API 1290 sends and/or receives one or more parameters through a parameter list or other structure.

In some embodiments, implementation module 1200 provides more than one API, each providing a different view of or with different aspects of functionality implemented by implementation module 1200. For example, one API of implementation module 1200 can provide a first set of functions and can be exposed to third party developers, and another API of implementation module 1200 can be hidden (e.g., not exposed) and provide a subset of the first set of functions and also provide another set of functions, such as testing or debugging functions which are not in the first set of functions. In some embodiments, implementation module 1200 calls one or more other components via an underlying API and thus be both an API calling module and an implementation module. It should be recognized that implementation module 1200 can include additional functions, methods, classes, data structures, and/or other features that are not specified through API 1290 and are not available to API calling module 1280. It should also be recognized that API calling module 1280 can be on the same system as implementation module 1200 or can be located remotely and access implementation module 1200 using API 1290 over a network. In some embodiments, implementation module 1200, API 1290, and/or API-calling module 1280 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

In some embodiments, methods described herein (e.g., as shown in FIG. 7 and FIG. 9) can be performed at a first computer system (as described herein) via a system process (e.g., an operating system process, a server system process) that is different from one or more applications executing and/or installed on the first computer system.

In some embodiments, the method can be performed at a first computer system (as described herein) by an application that is different from a system process. In some embodiments, the instructions of the application, when executed, control the first computer system to perform the method by calling an application programming interface (API) provided by the system process. In some embodiments, the application performs at least a portion of the method without calling the API.

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first party application). In other embodiments, the application is an application that is provided to the first computer system via an operating system update file (e.g., a first party application). In other embodiments, the application is an application that is provided via an application store. In some implementations, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform the method by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API.

In some embodiments, at least one API is a software module (e.g., a collection of computer-readable instructions) that provides an interface that allows a different module (e.g., API calling module) to access and use one or more functions, methods, procedures, data structures, classes, and/or other services provided by an implementation module of the system process. The API can define one or more parameters that are passed between the API calling module and the implementation module. In some embodiments, the API 1290 defines a first API call that can be provided by API calling module 1290. The implementation module can be a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 1250) that runs the application. In some embodiments, the implementation module is included in an electronic device that is separate from the device that runs the application.

In some embodiments, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium, such as a compact disk (CD) or DVD (digital versatile disk), flash memory, and the like. The computer readable medium may be any combination of such storage or transmission devices.

Computer programs incorporating various features of the present disclosure may be encoded on various computer readable storage media; suitable media include magnetic disk or tape, optical storage media, such as compact disk (CD) or DVD (digital versatile disk), flash memory, and the like. Computer readable storage media encoded with the program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. Any such computer readable medium may reside on or within a single computer product (e.g., a solid-state drive, a hard drive, a CD, or an entire computer system), and may be present on or within different computer products within a system or network. A computer system may include a monitor, printer, or other suitable display for providing any of the results mentioned herein to a user.

As described above, one aspect of the present technology is the gathering, sharing, and use of data, including proximity messages and data from which the proximity message is derived. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to determine a dwell spot using distance measurements that track a user through their daily routine. Further, other uses for personal information data that benefit the user are also contemplated by the present disclosure.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of sharing content and performing ranging, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

Although the present disclosure has been described with respect to specific embodiments, it will be appreciated that the disclosure is intended to cover all modifications and equivalents within the scope of the following claims.

All patents, patent applications, publications, and descriptions mentioned herein are incorporated by reference in their entirety for all purposes. None is admitted to be prior art.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

Implementations within the scope of the present disclosure include a computer-readable storage medium that encodes instructions organized as an application that, when executed by one or more processing units, control an electronic device to perform any of the methods described herein.

It should be recognized that the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, the application is an application that is pre-installed on device at purchase (e.g., a first party application). In other embodiments, the application is an application that is provided to the device via an operating system update file (e.g., a first party application or a second party application). In other embodiments, the application is an application that is provided via an application store. In some embodiments, the application store can be an application store that is pre-installed on the device at purchase (e.g., a first party application store). In other embodiments, the application store is a third-party application store (e.g., an application store that is provided by another application store, downloaded via a network, and/or read from a storage device).

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

1. A method performed by a mobile device for providing access control, the method comprising:
determining the mobile device crossed a geofence toward a predefined location;
responsive to crossing the geofence, communicating with a lock mechanism providing access to the predefined location via a wireless protocol;
classifying the mobile device as moving toward the predefined location based on wireless signals of the wireless protocol received from the lock mechanism;
dynamically adjusting a ranging rate with the lock mechanism based on the wireless signals; and
providing an unlock message to the lock mechanism, the unlock message indicating a range between the lock mechanism and the mobile device is less than a threshold.

2. The method of claim 1 further comprising:
determining, based on a wireless signal of a second wireless protocol, the mobile device as placed on a first side or a second side of the lock mechanism.

3. The method of claim 2, wherein determining the mobile device as placed on the first side or the second side of the lock mechanism is based on a differential signal strength.

4. The method of claim 3, wherein the second wireless protocol is an ultra-wide band protocol.

5. The method of claim 3, wherein the differential signal strength is based on a distance between one or more antennas within the lock mechanism.

6. The method of claim 3, wherein providing the unlock message to the lock mechanism occurs after determining that the mobile device is approaching from the first side of the lock mechanism.

7. The method of claim 1, wherein classifying the mobile device is based on sensor data from sensors of the mobile device.

8. The method of claim 7, wherein the sensors include an accelerator and gyroscope.

9. The method of claim 1 further comprising classifying the mobile device as being in a stationary state.

10. The method of claim 8 further comprising suspending communication between the mobile device and the lock mechanism.

11. The method of claim 9 further comprising classifying the mobile device as being in a non-stationary state and resuming communication between the mobile device and the lock mechanism.

12. The method of claim 1 further comprising suspending communication between the mobile device and the lock mechanism after the mobile device has not met the threshold within a predefined period of time after crossing the geofence.

13. The method of claim 1 further comprising utilizing an auxiliary processor of the mobile device to determine a proximity state of the mobile device to a predetermined location.

14-35. (canceled)

36. A non-transitory computer readable medium containing instructions that, when executed by one or more processors of a mobile device, cause the one or more processors to perform a method for providing access control, the method comprising:
determining the mobile device crossed a geofence toward a predefined location;
responsive to crossing the geofence, communicating with a lock mechanism providing access to the predefined location via a wireless protocol;
classifying the mobile device as moving toward the predefined location based on wireless signals of the wireless protocol received from the lock mechanism;
dynamically adjusting a ranging rate with the lock mechanism based on the wireless signals; and
providing an unlock message to the lock mechanism, the unlock message indicating a range between the lock mechanism and the mobile device is less than a threshold.

37. A system comprising one or more processors and a non-transitory computer readable medium containing instructions that, when executed by one or more processors of a mobile device, cause the system to perform a method for providing access control, the method comprising:
determining the mobile device crossed a geofence toward a predefined location;
responsive to crossing the geofence, communicating with a lock mechanism providing access to the predefined location via a wireless protocol;
classifying the mobile device as moving toward the predefined location based on wireless signals of the wireless protocol received from the lock mechanism;
dynamically adjusting a ranging rate with the lock mechanism based on the wireless signals; and
providing an unlock message to the lock mechanism, the unlock message indicating a range between the lock mechanism and the mobile device is less than a threshold.

38. (canceled)

39. (canceled)

40. The non-transitory computer readable medium of claim 36, wherein the method further comprises:
determining, based on a wireless signal of a second wireless protocol, the mobile device as placed on a first side or a second side of the lock mechanism.

41. The non-transitory computer readable medium of claim 36, wherein the method further comprises:
suspending communication between the mobile device and the lock mechanism after the mobile device has not met the threshold within a predefined period of time after crossing the geofence.

42. The system of claim 37, wherein the method further comprises:
determining, based on a wireless signal of a second wireless protocol, the mobile device as placed on a first side or a second side of the lock mechanism.

43. The system of claim 37, wherein classifying the mobile device is based on sensor data from sensors of the mobile device.

44. The system of claim 37, wherein the method further comprises:
suspending communication between the mobile device and the lock mechanism after the mobile device has not met the threshold within a predefined period of time after crossing the geofence.
